(19) United States
(12) Patent Application Publication
(10) Pub. No.: US 2019/0069631 A1
(43) Pub. Date: Mar. 7, 2019

(54) IMPACTING ABSORBING STRUCTURES IN FOOTWEAR

(71) Applicant: VICIS, INC., Seattle, WA (US)

(72) Inventors: Nathalie MITCHELL, Seattle, WA (US); Per REINHALL, Seattle, WA (US); Travis GLOVER, Seattle, WA (US); Anton ALFERNESS, Seattle, WA (US); Mike CZERSKI, Seattle, WA (US); Adam FRANK, Seattle, WA (US); Valerie CARRICABURU, Bellevue, WA (US); Andre STONE, Seattle, WA (US); Kurt FISCHER, Edmonds, WA (US); Jason NEUBAUER, Sammamish, WA (US)

(21) Appl. No.: 16/179,549

(22) Filed: Nov. 2, 2018

Related U.S. Application Data
(63) Continuation of application No. PCT/US17/31828, filed on May 9, 2017.
(60) Provisional application No. 62/333,652, filed on May 9, 2016.
(60) Provisional application No. 62/490,481, filed on Apr. 26, 2017.

(51) Int. Cl. A43B 13/18; A43B 3/00; A43B 13/12; A43B 13/04; A43B 7/32; A43B 7/14; A43B 13/20; A43B 1/00; A43B 13/14; A43B 7/08; A43B 5/06; B32B 3/18; B32B 5/18; B32B 27/06; B32B 27/40

(52) U.S. Cl. CPC A43B 13/181; B32B 2437/02; A43B 13/127; A43B 13/04; A43B 7/32; A43B 3/0005; A43B 7/148; A43B 7/1425; A43B 7/149; A43B 13/203; A43B 1/0009; A43B 13/148; A43B 13/188; A43B 7/082; A43B 7/081; A43B 5/06; B32B 3/18; B32B 5/18; B32B 27/065; B32B 27/40; A43B 3/0042

(57) ABSTRACT

Disclosed are systems, methods, procedures and devices incorporating a variety of impact absorbing structures (IAS) and/or buckling structure arrays into shoes, sneakers and/or other footwear, which can greatly enhance wearer comfort, improve shoe durability, improve athletic performance, reduce cost of manufacture and/or minimize impact forces to the foot, legs and/or lower body. Included herein are various types of footwear, foot coverings, lower extremity garments and related orthopedic sleeves and/or orthotics.

### CROSS-REFERENCE TO RELATED APPLICATIONS

This application is a continuation of Patent Cooperation Treaty Patent Application Serial No. PCT/US17/31828 entitled “IMPACTING ABSORBING STRUCTURES IN FOOTWEAR,” filed May 9, 2017, which in turn claims the benefit of U.S. Provisional Patent Application Ser. No. 62/333,652 entitled “IMPACTING ABSORBING STRUCTURES IN FOOTWEAR,” filed May 9, 2016, and U.S. Provisional Patent Application Ser. No. 62/490,481 entitled “IMPACTING ABSORBING STRUCTURES IN FOOTWEAR,” filed Apr. 26, 2017, the disclosures of which are each incorporated by reference herein in their entireties.

### TECHNICAL FIELD

The present invention relates to devices, system and methods for incorporating impact absorbing materials, impact absorbing structures, buckling structures and/or various combinations thereof into footwear and/or foot and leg coverings to increase comfort for the wearer, improve athletic performance and/or minimize, reduce, accelerate, delay and/or redirect the transmission of impact forces to the foot, legs and/or lower body. Included are various types of footwear, foot coverings, lower extremity garments, orthopedic and/or orthotic implants and related methods, designs, systems and models. In various embodiments, patient-specific and/or patient-adapted features for an individual user or group of users can be incorporated.

### BACKGROUND OF THE INVENTION

Footwear and foot/leg coverings serve a variety of purposes for humans, mammals and/or other animals, namely ensuring comfort of the feet and legs while standing, walking, or performing other activities, protecting the feet, lower legs, knees, and hips from injury during activity, and enhancing the performance of athletes during competitive activities. Current footwear (i.e. shoes, sneakers, boots or sandals) is generally constructed by attaching an upper section, the “upper”, to a lower section, the “sole”. The upper section partially or completely covers the top of, and holds the shoe onto, the wearer's foot. The lower section provides a comfortable surface or platform for the wearer, protects the bottom of the wearer's foot from injury and impact, limits some impact forces from translating into the lower body of the wearer, and provides traction when the wearer is walking or running over various surfaces. The sole and foot bed of current footwear provides some degree of cushioning for comfort and impact protection, however this cushioning is often insufficient to prevent discomfort and various foot and lower body injuries that are encountered during competitive and recreational activities.

### BRIEF SUMMARY OF THE INVENTION

Current footwear is limited in that a large number of injuries and maladies can be caused by inadequate and/or improper footwear design and/or selection. These injuries and maladies can include any pain, discomfort, or tissue damage due to inadequate impact protection, lack of cushioning, and/or improper fit. To address many of these issues, footwear designs are herein proposed that incorporate one or more impact absorbing structures (IAS) comprising filaments, columns and/or other buckling structures into arrays in a shoe component or other footwear element that can desirably absorb repetitive ground impacts, reduce peak foot and/or extremity loading, improve gait dynamics and/or improve energy return and athletic performance, without significantly increasing the overall cost and/or durability of athletic or other footwear.

In various embodiments, IAS arrays can be incorporated into various components of a shoe or other footwear, including into the sole, toe box, collar, tongue, vamp and/or other component structures of the shoe to desirably improve shoe comfort and fit, improve impact absorption, enhance distribution of impact energy to the foot and lower extremity, minimize peak loading and improve energy return for athletic performance. The use of buckling structures and associates IAS arrays in such applications can greatly facilitate the performance of impact absorbing structures in a relatively small and compact footprint. Moreover, IAS arrays can be utilized to supplement and/or replace many existing shoe support structures, often without requiring significant redesign or alteration of many components of an existing shoe configuration.

In various embodiments, the ability to “tune” the buckling response of filaments and columns in IAS arrays can greatly enhance the adaptability and/or utility of existing and/or improved shoe designs, including the ability to modify shoe performance in a desired manner to accommodate the unique requirements of a specific sport or athletic endeavor and/or the needs of the athletes participating therein. In various embodiments, a shoe design and/or shoe performance can be particularized to the specific needs of an individual athlete and/or group of athletes, which could include shoe designs that perform “differently” under similar loading during different circumstances, which could include the ability for a user to manually and/or automatically modify their shoe response in a desired manner.

In various embodiment, the incorporation of IAS arrays and buckling structures can significantly enhance the durability of shoe cushioning structures, including reducing and/or eliminating environmental stress cracking, fracture and/or collapse of existing cushioning materials such as polyurethane foams having limited shelf life and/or degradable components. Properly designed, IAS arrays can also be much more durable than existing cushioning materials, and can incorporate localized variations in filament distribution and/or impact response that are difficult and/or expensive to accomplish using traditional materials. Moreover, IAS arrays and buckling structures can be designed and formed to accommodate and/or disperse water and/or sweat, and can be configured to greatly reduce the opportunity for mold, pollutants and/or other materials to invade and/or degrade shoe materials.

### BRIEF DESCRIPTION OF THE SEVERAL VIEWS OF THE DRAWINGS

The foregoing and other objects, aspects, features, and advantages of embodiments will become more apparent and may be better understood by referring to the following description, taken in conjunction with the accompanying drawings, in which:

FIG. 1A shows a cross sectional view of a typical modern running shoe;

FIG. 1B depicts a perspective view of a shoe, with various internal components shown in dotted lines;

FIG. 1C depicts a perspective view of a running shoe with an exploded view of the sole structures;

FIG. 2 depicts an exemplary embodiment of an Impact Absorbing Structure (IAS) constructed in accordance with various teachings of the present invention;

FIG. 3A depicts one potential response to an incident force of the exemplary IAS of FIG. 2;

FIGS. 3B and 3C depict various potential responses to varying impact forces on the exemplary IAS of FIG. 2;

FIG. 3D depicts another exemplary potential response of the IAS of FIG. 2 to an incident force F;

FIG. 3E depicts an alternative embodiment of an IAS constructed in accordance with various teachings of the present invention;

FIGS. 4A and 4B depict one exemplary embodiment of a composite sole having a plurality of individual sole sections;

FIG. 5 depicts another exemplary embodiment of a composite sole having a plurality of individual sole sections;

FIG. 6 depicts an exemplary graphical representation of the pressure pattern and loading cycle of a runner's foot during running;

FIG. 7A depicts a top plan view of an exemplary left sole with ball and heel IAS inserts;

FIG. 7B depicts a perspective view of a shoe sole having voids for accommodating one or more IAS inserts;

FIG. 8 depicts an exemplary pedobarographic pressure distribution mask for a single foot during user motion;

FIG. 9A depicts a side view of a shoe sole, with some typical peak pressure points indicated;

FIG. 9B depicts a side view of the shoe sole of FIG. 9A, showing exemplary IAS embodiment variants that desirably accommodate various peak pressure forces and/or directions;

FIG. 10A depicts an exemplary matrix of generally cylindrical columns or filaments made from an elastic material, which could serve as part of an IAS matrix;

FIG. 10B depicts one alternative embodiment of an IAS matrix or filament bed, incorporating generally cylindrical columns of varying lengths and/or diameters;

FIG. 11A depicts one embodiment of hexagonal filaments for use in an IAS matrix;

FIG. 11B depicts a filament bed incorporating a single face sheet and/or intermediate columnar projections;

FIG. 11C depicts a filament bed having an intermediate constraining structure or sheet;

FIG. 12A depicts an exemplary IAS array comprising a dense network of regularly and/or irregularly spaced smaller diameter columns;

FIG. 12B depicts another exemplary IAS array comprising a less-dense network of regularly and/or irregularly spaced larger diameter columns;

FIG. 12C depicts another exemplary IAS array comprising a network of elongate and/or irregularly-shaped filaments;

FIG. 12D depicts another exemplary IAS array comprising a network of angled filaments;

FIG. 12E depicts another exemplary IAS array comprising a network of opposing or crossing angle filaments;

FIGS. 13A through 13I depict various alternative embodiments of exemplary IAS filament arrays, including embodiments comprising a variety of filament designs, arrangements, shapes, sizes, cross-sections, distributions, materials and/or configurations;

FIG. 14A depicts one exemplary embodiment of an energy absorption and/or return system for a shoe;

FIG. 14B depicts a bottom perspective view of another exemplary embodiment of an energy absorption and/or return system for a shoe, optionally incorporating a plurality of laterally spaced tension and/or compression bands;

FIGS. 15A through 15D depict cross-sectional views of various exemplary embodiments of IAS configurations potentially useful in addressing shoe impact forces;

FIGS. 16A through 16D depict cross-sectional view of various exemplary layers incorporating IAS arrays;

FIG. 17A depicts one exemplary embodiment of a solid and/or semi-solid sole layer incorporated into an IAS-configured shoe sole;

FIG. 17B depicts an alternative embodiment of a solid and/or semi-solid sole layer incorporated into an IAS-configured shoe sole;

FIGS. 18A though 18I depict various alternative embodiments of exemplary IAS and array configurations, including IAS designs and/or arrays that can be incorporated into various shoe and footwear components;

FIG. 19A depicts one exemplary embodiment of a sensor system for use in monitoring and/or recording the shoe activity of a user;

FIG. 19B is a symbolic depiction of various data transmission and/or monitoring systems for use with possible shoe sensor systems;

FIGS. 20A and 20B depict exemplary designs for incorporating IAS arrays and other buckling structures into fabrics, highly flexible structures and/or onto/into soft goods;

FIGS. 21A and 21B depict one exemplary embodiment of upper and lower IAS components that can be combined together to form a composite IAS array;

FIG. 21C depicts an exemplary technique for assembling a composite IAS array;

FIG. 21D depicts an exemplary combined element of a composite IAS array;

FIGS. 22A through 22C depict alternative embodiments of upper components for a composite IAS array, wherein each upper component could alter the performance of the combined IAS array;

FIGS. 23A through 23D depict various exemplary embodiments of boundary and/or internals walls or other structures that can form a portion of the IAS array or IAS array containment feature, and/or which can assist an IAS array with absorbing and/or otherwise resisting non-axial, rotational, lateral and/or other loading of the filament array;

FIGS. 24A through 24C depict exemplary sheets, tension band and/or compression bands that can be incorporated into the filaments of IAS arrays to desirably alter the impact absorption and/or buckling performance of some or all of the filaments therein;

FIG. 24D depicts an alternative embodiment of a constraining system for constraining and/or controlling the buckling response of some or all of the filaments in an IAS array in a desired manner;

FIG. 25A depicts one embodiment of a shoe lower half incorporating a replaceable and/or configurable sole cartridge;

FIG. 25B depicts one exemplary embodiment of a sole “cartridge” for use with the shoe lower half of FIG. 25A, in which the sole incorporates one or more IAS arrays, with a central region comprising a flexible “trampoline bed,” pre-buckled filaments are located around the perimeter of the cartridge, and peripheral openings are provided in the edges to allow air to leave and enter the sole as a desired rate during compression and/or relaxation of the sole; and

FIG. 26 depicts an exemplary graph of stress-strain behavior of filaments of an IAS array, in which variations in the filament structures, forms, sizes, shapes, distributions, materials, boundary walls, boundary conditions and/or other constraints can alter the compressive and/or buckling response of the array.

### DETAILED DESCRIPTION OF THE INVENTION

In various embodiments, a shoe is disclosed that includes an upper attached to a sole. The sole consists of the upper foot bed and the lower sole. The upper foot bed (i.e., the “foot bed”) is the structure which contacts the foot of the wearer and the lower sole (i.e., the “sole”) is the structure that contacts the ground. In between these two structures, various impact absorbing materials, impact absorbing structures, or combinations of impact absorbing materials and impact absorbing structures may be placed to increase comfort for the wearer and reduce the transmission of impact forces to the foot, legs, or lower body. Hereafter, these impact absorbing material and structures are collectively referred to as IAS.

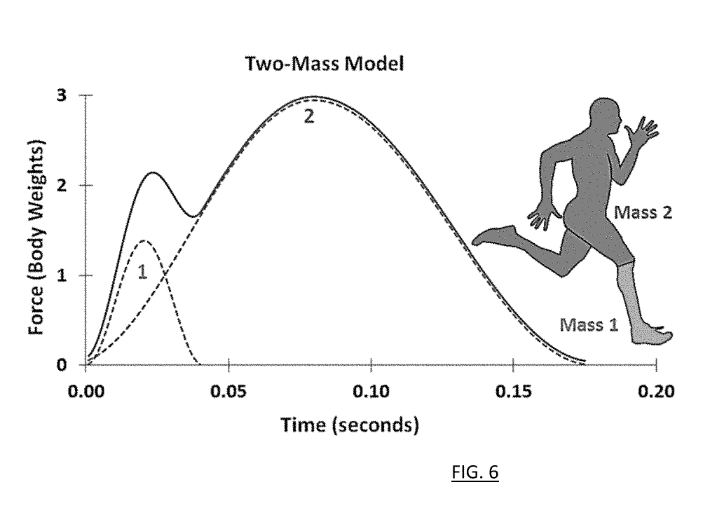

Feet and related support structures accommodate a wide variety of loads during daily movement activities, with even greater loading experienced during sports and period of increased activity. During running activities, for example, a runner's feet often experience a repetitive loading cycle based on their running patterns, including “heel strike,” “mid-foot strike” and “foot strike” running, with a simplified graphical form of “heel strike” loading depicted in FIG. 6. In this Figure, the runner's body can be separated into two masses: Mass 1 (the runner's feet and lower legs below the knee) and Mass 2 (the runner's thighs and remainder of the body). As each foot hits the ground (initially starting from time “0”), the runner's foot typically experiences an initial impact loading of approximately 1.4 times the runner's body weight (due to the Mass 1 loads) plus approximately 0.6 times the runner's body weight (due to the Mass 2 loads) for an initial peak loading of 2 times the runner's body weight. This initial impact loading then subsides slightly for a brief period as the body rebounds from the initial impact, and then foot loading rapidly increases to three times the runner's body weight when the full weight of the runner's body is supported by the foot and the runner's foot begins to recoil and toe-flex to push the body upwards and forwards to the next stride.

Impact loading in running is the equivalent of striking a runner's heel and foot sole with a hammer using 1.4 to 3 times their body weight for each blow, which is repeated over 1000 times for each mile run. Not surprisingly, these intense loading cycles can result in stress fractures of the various foot bones, including the second and third metatarsals of the foot (which are thinner and often longer than the adjacent first metatarsal), as well as the calcaneus (i.e., heel), the fibula (the outer bone of the lower leg and ankle), the talus (a small bone in the ankle joint) and the navicular (a bone on the top of the midfoot).

In addition to stress fractures of the bones of the foot and lower leg, a wide variety of injuries and maladies can be traced, fully or at least in part, to deficiencies and inadequacies in current footwear designs. These injuries, which can include pain, discomfort and tissue damage due to inadequate impact protection, lack of cushioning, or improper fit, are often common occurrences for runners and other athletes, and can include (but are not limited to):

FOOT INJURIES

| | | |
|---|---|---|
| Black Toenail | Bunion | Calcaneal Bursa (heel) |
| Hallux Rigidus (Toe) | Ingrowing Toenail | March Fracture (toe) |
| Mortons Neuroma | Plantar Fasciitis | |
| (forefoot) | | |

ANKLE-AREA INJURIES

| | | |
|---|---|---|
| Achilles Rupture (complete | Ankle Pain | Ankle Sprain |
| or partial) | | |
| Peritendinitis (Achilles) | Achilles Tendonitis | |

LOWER LEG INJURIES

| | | |
|---|---|---|
| Anterior Compartment | Calf tear | Shin splints |
| Syndrome | | |
| Stress Fractures | Tibial Periositis | |
| | (shin) | |

KNEE INJURIES

| | | |
|---|---|---|
| Patellofemoral pain | Anterior Cruciate | Baker's Cyst |
| syndrome (PFPS) or | Ligament injury | |
| Runner's Knee | | |
| Hoffars syndrome | Medial Collateral | Meniscal Cyst |
| | Ligament injury | |
| Meniscal Injuries | Osgood-Schlatters | Patellar Tendinitis |
| | disease | |
| Posterior Compartment | | |
| Syndrome | | |

UPPER-LEG INJURIES

| | | |
|---|---|---|
| Hamstring Injuries | Muscle Hernia | Quadriceps Injuries |

HIP INJURIES

| | |
|---|---|
| Adductor Injuries | lliotibial Band |
| | Syndrome (ITBS) |

It is believed that the peak impact loads, loading directions/responses and/or repetitive foot loading provided by current shoe designs is suboptimal, in that current shoe designs continue to allow the wide variety of injuries described above (as well as many others). To address these various issues with current designs, it is proposed that one or more IAS matrices can be positioned in between the foot bed and the sole and can incorporate sufficient strength and structural integrity to resist, delay and/or redirect forces from the impact of running and other athletic sports. Additionally, the structures within the IAS array may undergo deformation (e.g., buckling) when subjected to forces from a sufficiently strong impact force. As a result of the structure design, arrangement and performance, including deformation and buckling, the IAS array(s) desirably reduces peak energy transmitted from the sole to the foot bed, and thereby moderates, reduces and/or redirects the various forces transmitted to the wearer's feet and legs. In various embodiments, the IAS matrix may also allow the sole to move independently of the foot bed in a variety of planes or directions. In this manner and others, the IAS desirably may reduce the incidence and severity of impact as a result of sports and other activities.

The various aspects and features of the embodiment disclosed herein are intended to apply to all structures used to protect various portions of the human anatomy from impact and/or injury.

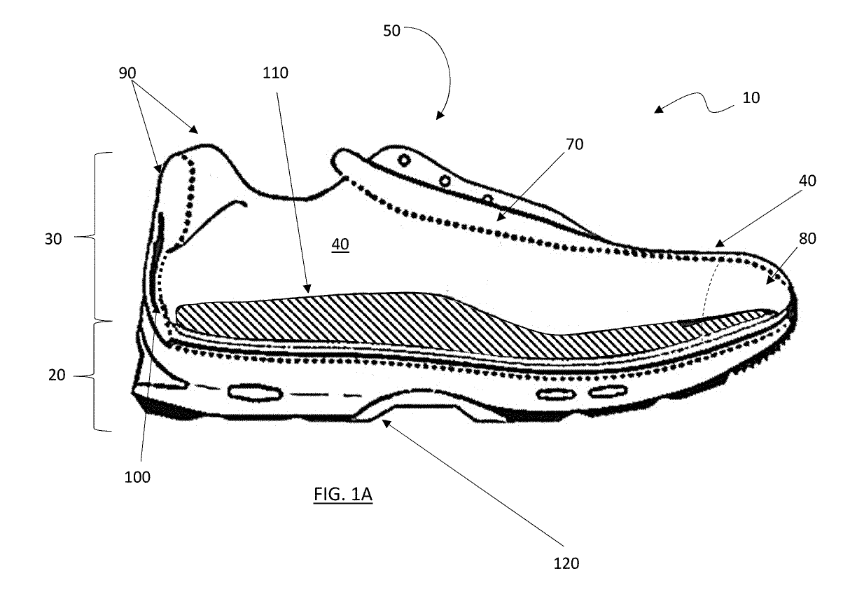

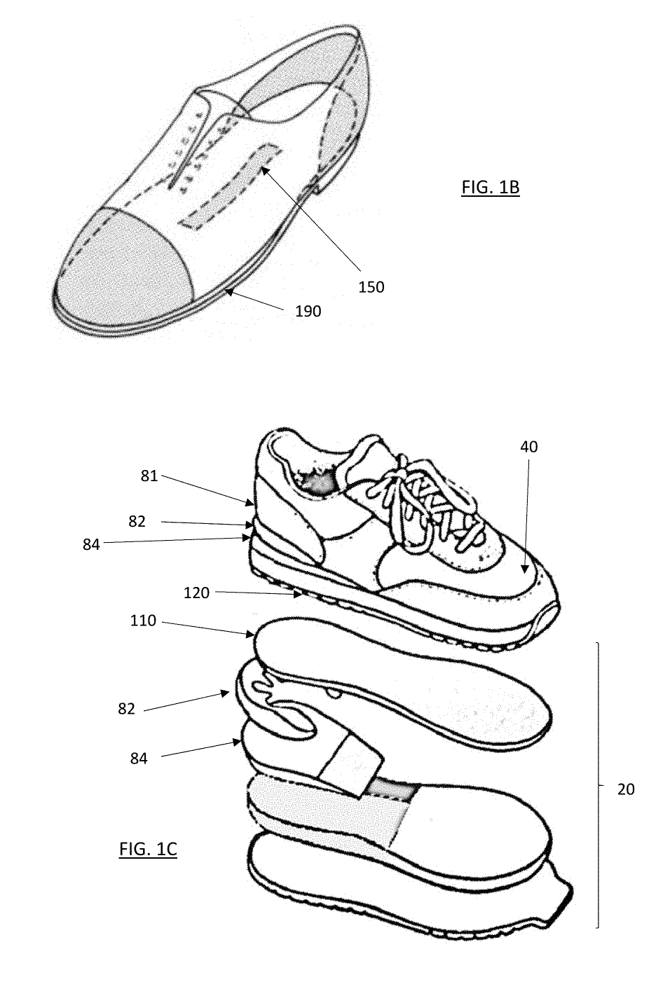

FIG. 1A shows a cross sectional view of a typical modern running shoe 10, although this shoe is generally representative of many different types of footwear in general, and FIG. 1C depicts a perspective and exploded view of the sole structures of a commonly available running shoe. The shoe 10 includes a variety of component parts (up to 20 or more components, in some shoe designs), which generally includes the sole 20 and the upper section 30, with the upper section typically comprising all parts or sections of the shoe above the sole 20. The upper includes the vamp 40 or toe box (i.e., the front of the shoe), the quarters 50 and 60 (i.e., the side and back of the shoe), and the linings (not shown). The vamp 40 (including the tongue piece 70) covers the top (i.e., cephalad or dorsal aspect) of the foot and provides a protective surface over the toes. A toe puff 80, typically of thermoplastic material, can be provided within the vamp (i.e., over the toes) to provide shape and structure to the vamp, and also to protect the toes to some limited degree. If desired, the toe puff 80 can be reinforced with structural materials such as aluminum and/or steel for additional toe/foot protection (i.e., steel-toed work boots and shoes).

The quarters 50 and 60 are the upper part of the shoe behind the vamp 40, which cover the sides and back of the shoe. The top edges, sides and back of the quarters define a topline structure 90. In many shoes, especially athletic and/or active-wear shoes, the topline can be padded, which is often referred to as a collar (not shown). In some lacing-type shoes, the eyelets may be formed from a part of the quarters, with the tongue comprising part of the vamp, while in other lacing-type shoes the eyelets and lacing may form part of the vamp.

A heel section of the quarters 50 and 60 is often reinforced with a stiffening member 100 to assist with support of the rearfoot. The stiffening member (or counter) can be a component of the quarter that stabilizes the hindfoot. For people who pronate, the counter is desirably very stiff. In contrast, for those that supinate, the counter should be more flexible and giving. In boots, the quarter is often referred to as the “top.”

The sole 20 comprises an insole or inner sole 110 that is a layer of material shaped to the bottom of the last (a “last” is the foot form used in construction of the shoe—not shown) and is sandwiched between the outsole 120 and the sole of the foot (not shown) inside of the shoe. In many shoe designs, the insole 110 covers the join between the upper 30 and the sole 20 in many shoe designs, and typically provides attachment points for the upper, toe box, linings and welting. For some designs, the insole is necessary to allow for cementing or other attachment of the upper and lowers shoe portions together.

In various embodiments, the inner sole or foot bed may be somewhat rigid to serve as a stable platform for the wearer or spread impact forces over a wider area of the impact, or it may be more flexible for comfort. The sole may also be somewhat rigid to increase protection from sharp objects or it may be more flexible or conformable to provide better traction and impact absorption.

The sole 20 further comprises an outer sole or outsole portion 120, which is the outermost portion of the sole and includes external structures that are directly exposed to abrasion and wear during use. The outsole is often formed from a variety of different materials, each of which are often constructed in different thicknesses and/or degrees of flexibility. Ideal soling materials include materials that are waterproof, durable and desirably non-slip and/or roughened (i.e., they desirably prevent the shoe from slipping on smooth surfaces). There are a wide variety of surface designs available for the bottom contact surface, and extra gripping properties can be incorporated into the sole in the form of waffle-type or other sole patterns well known in the art. The sole features will often be molded with cavities to reduce the weight of the sole, which can be covered with a more rigid insole and/or filled with light foam to produce a more flexible sole. In many cases, two or more materials having different properties will be incorporated into a sole construction, with a stronger, more wear-resistant material for the outer sole surface and a softer, more flexible midsole for greater comfort.

The bottom of the sole has three main parts, outsole, midsole, and wedge. The outsole provides traction and absorbs shock. The midsole is designed specifically for shock absorption, and the wedge supports the heel. In many shoe designs, the posterior portions of the midsole are often relatively firm, while the anterior portions of the midsole are relatively softer and/or more flexible. Located inside the shoe, the insole also contains the arch support (sometimes called the “arch cookie”). In many shoe designs, a heel counter support 82 and heel counter wedge are often provided. The heel counter 81 can be a relatively inflexible material surrounding the heel, and is typically made from a material that is both rigid and durable, to support and stabilize the heel. When the inner heel counter begins to break down (i.e., in a pair of older, worn shoes), the inner heel counter tends to lose its stiffness, which is why an external counter may be placed between the midsole and the base of the heel counter. In many designs, a heel wedge 84 is provided that adds height to the heel and enhances the shoe's ability to absorb shock and reduce strain. The advantage to the added heel height of such a design is that the component arrangement can cause shortening of the Achilles and Gastrocnemius-soleus muscle, desirably reducing the strain upon these important posterior running structures. However, the resulting higher heel height may feel less stable to the wearer, and may further result in reduced flexibility in the tendon structure after prolonged use.

A shank 150 (see FIG. 1B) can be provided in and/or proximate to the sole (or between the sole and the insole) which bridges the heel breast (the forward-facing part of the heel, under the arch of the sole) with the ball tread (under the forward ball of the sole of the foot). The shank or shankpiece (or “shank spring”) can comprise a rigid or more flexible, springy member made from wood, metal, fiberglass and/or plastic, and in many shoe designs includes a piece up to 10 cm long and 1.5 cm wide. The shankpiece typically lies within the bridge of waist of the shoe (i.e., between heel and ball of foot, corresponding to the medial and lateral arches of the foot). The shankpiece desirably reinforces the waist (i.e., middle) of the shoe and prevents it from collapsing or distorting during wear. The contour of the shankpiece is typically defined by the heel height, with shoes having low heels or wedge-type soles typically not having a shankpiece as the torque between the rear and forefoot structures of the shoe generally does not distort the shoe to a significant degree in these designs.

A heel 160 is the raised component under the rear of the shoe. Heels can be formed in a wide variety of shapes, heights, and materials, and heels typically comprise a series of raised platforms or hollowed sections, with the heel seat or heel base portion typically shaped to fit the heel of the wearer. The heel breast is the front-facing portion of the heel, and the ground contact section of the heel is the top piece. In most designs, heels raise the rear of the shoe above the ground. Other shoe designs without a heel or midsole wedge may be completely flat, and when the heel section sits lower than the forefoot the style is called a “negative heel.”

The welt 190 is the strip of material that joins the upper to the sole, which in more expensive shoe designs is often bonded using “Goodyear-Welting.” Other shoe designs incorporate less expensive “Blake Welting,” while adhesives or cementing can often be used with the least expensive shoes and/or for shoes with gummy, flexible soles (i.e., sneakers and rubber soled shoes).

In modern running shoes, the sole has three layers: insole, midsole and outsole. The insole can be made of a thin layer material, such as man-made ethylene vinyl acetate (EVA). The midsole, which typically provides the bulk of the cushioning, varies among manufacturers, but generally consists of polyurethane surrounding another material such as gel or liquid silicone or polyurethane foam (with polyurethane foam surrounding compressed air capsules in some designs). Outsoles are usually made of carbon rubber, which is hard, or a softer type of blown rubber, although a wide variety of surface materials and treatments can be used to produce different textures on the outside of the shoe. The remainder of the shoe typically includes a covering, which is usually a synthetic material such as artificial suede or nylon weave, with plastic slabs or boards to support the shoe shape, or a leather or nylon overlay. Cloth components can also be used in various designs, but are typically limited to the laces fitted through plastic eyelets, with adhesive cements bonding the entire shoe together.

Modern shoe design involves very detailed research on the mechanics of human walking, running and/or other movements, which are united with physics principles regarding motion, balance, pressure, friction, and quality of materials. This is because the ultimate goal of a running shoe is to accommodate and improve on the biomechanics of the human body during running, while also mitigating and/or minimizing the deleterious effects of impact forces, injuries and/or other repetitive stresses experienced by the runner.

For example, a normal human foot will often abrade or become “raw” on its ground contact surface after running barefoot on some surfaces (notwithstanding some world renown “barefoot” runners from Kenya), so the outsole of the shoe (in combination with the inner cushioning materials) will desirably provide cushioning and protection to the sole of the runner's foot to prevent such injuries from happening. However, the shoe should also desirably remain quite flexible to allow the runner's foot to maintain a natural or equivalent range of normal motion, which cuts against significant rigidity in the shoe's overall construction. In many cases a single material will not adequately address the many competing interests inherent in a specific shoe design (or components thereof), and thus shoe designers are often forced to accept “trade-offs” in the materials and construction techniques used in the various features of a shoe design, which often leads to suboptimal shoe performance, added shoe expense and/or limited durability of the shoe itself.

To complicate shoe design even further, shoe designers, shoemakers and shoe retailers have to contend with the complicated reality of pleasing runners and other athletes with different feet types, running styles, and tastes in shoes. Some feet roll inwards, others outwards. Some feet are narrow, while others are wider than normal. While a generic shoe would be desirable for a large class of runner (and might serve to better optimize manufacturing costs), such generic designs would typically have to compromise on various qualities in its attempt to accommodate diversity. Instead, many manufacturers currently typically offer numerous choices of shoe designs to attempt to keep everyone satisfied.

In an effort to make running shoes comfortable for runners, most modern running shoe designs incorporate different types of polymer foams and/or “bladders” into the shoe soles. For example, many shoes manufacturers pack their shoe soles with ethyl vinyl acetate (EVA) foam, which makes these soles feel cushy. Other manufacturers use polyurethane (PU) foam, thermoplastic polyurethane (TPU) foam, lightweight foamed EVA, EVA-bound blends and a variety of proprietary foam blends and/or biodegradable foams. Aside from altering the ingredients in the various foam blends to desirably alter the mechanical properties of different foams, shoe designers often combine different types of foam layers into a single sole to desirably alter the properties of the foam in a given set of shoes.

IAS and Other Buckling Structures

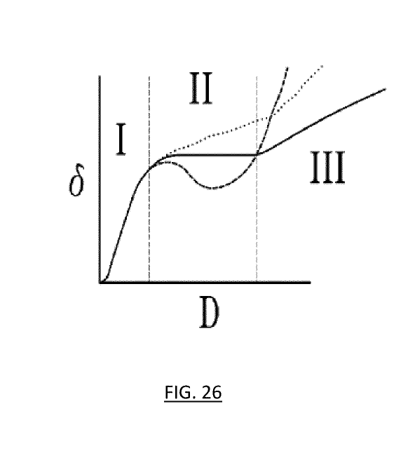

Various aspects of the present invention include the realization of a need for various types of IAS and/or macroscopic support structures for replacing and/or augmenting various components and/or portions thereof in traditional shoes and other footwear, including in athletic and running shoes. In various embodiments, the incorporation of macroscopic support structures such as buckling structures can significantly increase the performance of existing shoe materials in a desirable manner, as well as enable and/or facilitate the use of materials in shoe design that were heretofore useless, suboptimal and/or marginally useful in standard shoe designs. For example, macroscopic buckling structures or IAS's can potentially enable the use of metallic columns and/or foamed metals in the creation of soft, flexible shoe soles having incredible strength and durability at a reasonable cost, which was heretofore impossible to accomplish. In effect, the compressive response and rebound behavior of many existing materials can desirably be “tuned” (using buckling structures and IAS arrays as described herein) to almost ANY response, as desired (using various combinations of structure forms, sizes, shapes, distributions and/or materials, for example)—See FIG. 26. This arrangement greatly enhances the use of old materials in new applications for which they may have been unsuitable. As another example, one or more properly designed and/or positioned IAS arrays and/or buckling structures can be formed from natural and/or artificial rubbers or similar materials, which can provide an extremely durably cushioning and/or sole structure with a similar response and expense of polyurethane foam, if desired.

In various embodiment, IAS's can be specifically designed to resist impact forces in a desired manner, with the buckling structures incorporated into various shoe components, such as the insoles and/or midsoles of shoes. If desired, such structures could provide linear and/or non-linear resistances to loads and/or impact forces, including the ability to resist impact forces in a non-Newtonian manner, when desired. Moreover, various designs of macroscopic buckling structures can allow for customizing, tuning and/or modification (i.e., manual, automatic and/or various combinations thereof) of the impact resistance and performance criteria of individual buckling structures, including altering the performance of a single set of running shoes for a variety of different athlete shapes, sizes and/or running styles.

In various embodiments, one or more filament layers can be provided for impact absorption in various locations of the shoe, such as in the sole underneath the foot, with the filament layer including a plurality of buckling structures configured to deform non-linearly in response to an incident force.

In various of the figures that follow, the structures and/or materials described may be placed in between the foot bed and sole, either as described or in combination with other materials or structures. In general, the various described structures may be made of foams, elastomers, polymers, rubbers and/or metals, which in a proper configuration can compress and/or buckle in a predetermined manner to desirably reduce impact forces, reduce peak loading, better distribute forces across larger areas of the foot and/or provide for improved “rebound” and shoe performance. Although not shown in all cases, layers of foam or other materials (i.e., open cell, closed cell, memory foam, or non-Newtonian fluids) might be layered in or among the IAS matrices to provide cushioning, impact absorption, stability, preferred “failure” zones, directions or areas, and/or rigidity as needed to support the wearer during a variety of activities.

It should be understood that the various IAS matrices and structures described herein could have equal or greater utility in other areas of the shoe, other than the sole, and the use of such buckling structures in other shoe components is specifically contemplated herein. For example, IAS or similar structures might be particularly useful when incorporated into the toe box and/or collar of the shoe, including the use of rate sensitive and/or non-Newtonian fluids to provide high-impact protection for sensitive foot anatomy while concurrently allowing for flexibility of those shoe regions, and IAS arrays or similar structures might have improved utility in the tongue or vamp to facilitate shoe sizing and/or shoe retention during activities such as running or sports. In various alternative embodiments, IAS arrays and/or other buckling structures can be utilized in one or more of the following: (1) in a heel strike plate (i.e. under and/or around heel/ankle of foot), (2) in a foot strike plate (i.e., under ball of foot and/or toe structures), (3) under the mid-foot region (i.e., proximate to the arch of the foot), (4) around the outer periphery of the heel (i.e., to increase comfort and/or fitment of the shoe, including shoe retention on the user's foot), (5) over the top of the foot (i.e., to secure the foot within shoe and/or protect foot from laces/Velcro™/tongue and/or downward impact forces, including use as a tongue replacement), and/or (6) in various other locations to support specific shoe and/or foot “designs” or performance.

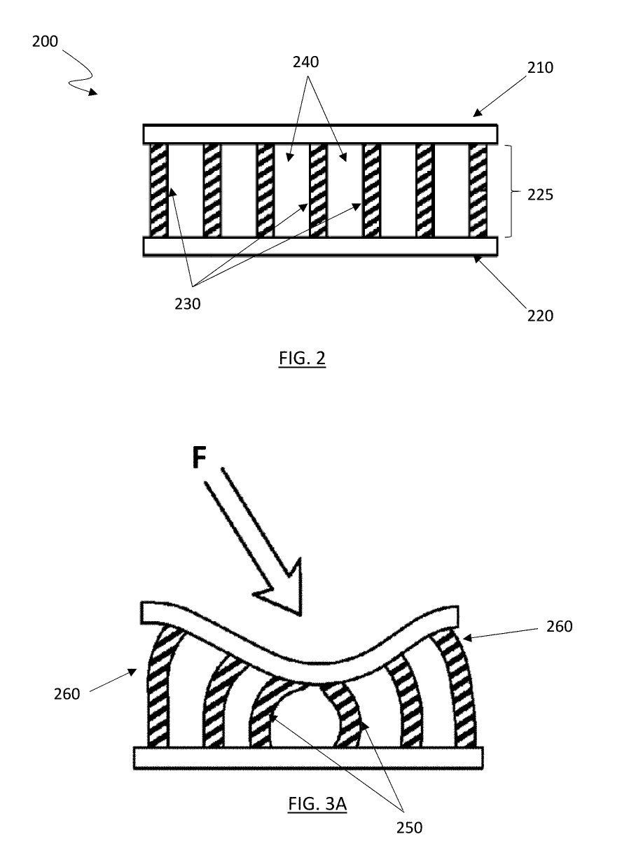

As best seen in FIG. 2, one embodiment of a IAS filament layer 200 can comprise an upper layer 210, a lower layer 220 and space or gap 225 between the upper and lower layers. A plurality of individual filaments 230 can be disposed within the space 225, which may be separated by a series of open areas or voids 240, if desired. In various embodiments, the voids 240 could be filled with air, liquids and/or solid materials such as low density foam, etc., which might be spaced apart from and/or contact the various filaments, as desired. In the illustrated embodiment, the filaments 230 can extend between the upper layer 210 and lower layer 220, and substantially span the space 225. If desired, padding or other materials (not shown) could be provided adjacent to the upper and/or lower layers, including padding adjacent to the sole of the foot and/or to an inner layer of sole material, which could be configured to comfortably conform to a foot of the wearer (not shown).

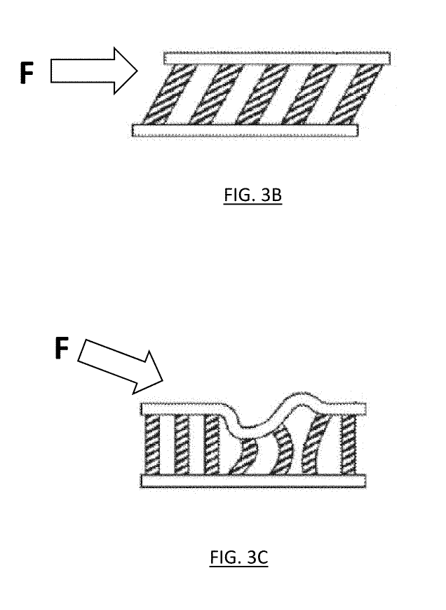

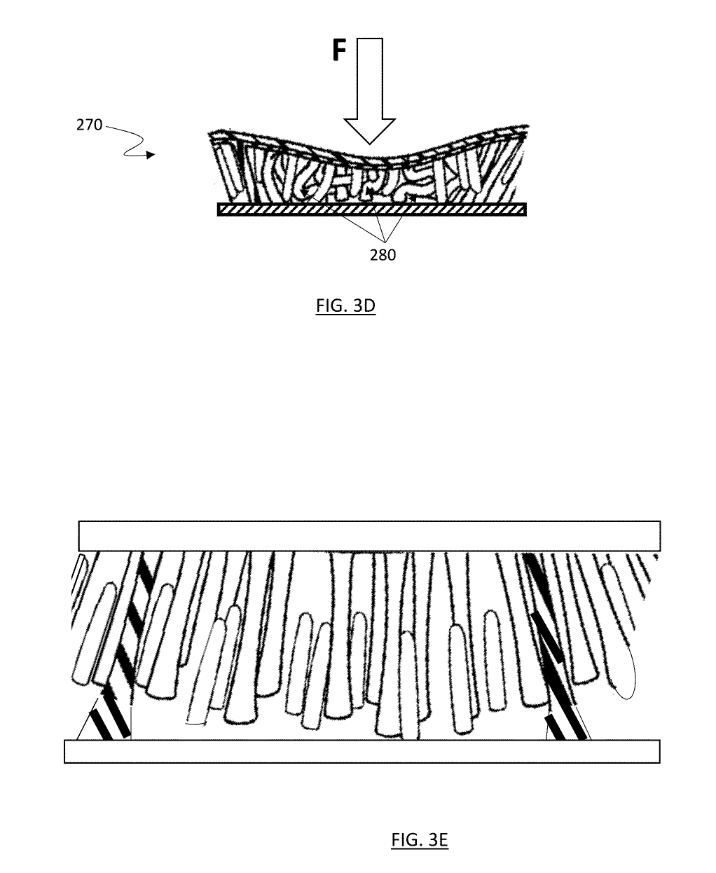

FIG. 3A depicts one potential response of the exemplary filament layer 200 of an IAS to an incident force F, where the magnitude of the incident force causes some centrally located filaments 250 to “buckle” sideways in response to the force, while other peripherally located filaments 260 may “bend” or otherwise compressively deform in a linear or other manner (and possibly “buckle” to some degree, depending upon their proximity to the impact force). FIG. 3D depicts another potential response of an exemplary filament layer 270 of an IAS to an incident force F, where the magnitude of the incident force causes many of the filaments 280 directly below and in proximity to the force F to “buckle” in a complex array of lateral directions in response to the force.

FIGS. 3B through 3D show how the columns or filaments of an IAS may compress and/or “buckle” upon application of an impact, either locally upon impact normal to the sole, or upon a sideways or shear force.

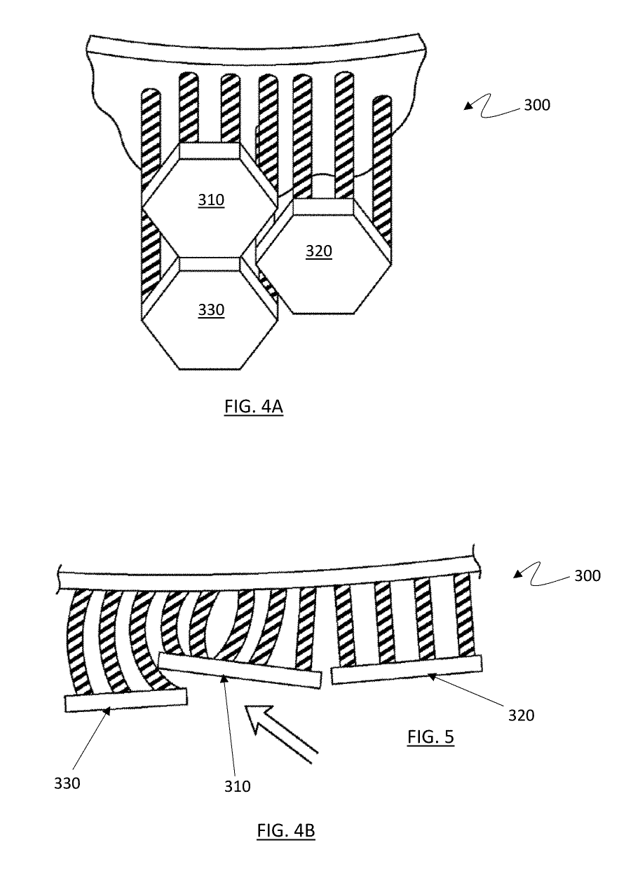

In various embodiments, the lower layer 220 may comprise and/or be adjacent to a harder, more durable outer layer (not shown), which typically forms the bottom of the sole of a shoe. In some embodiments, the outer layer may comprise a single, continuous shoe sole, while in other embodiments the shoe sole may comprise a plurality of individual sole elements (which may include sole elements capable of independent movement relative to each other). FIGS. 4A and 4B depict one exemplary embodiment of a composite sole 300 having a plurality of individual sole sections 310, 20 and 330. In this embodiment, each of the sole sections is capable of independent movement relative to adjacent sole sections, including an ability to slide over and/or under adjacent sections under various loading conditions (see FIG. 4B). In other alternative embodiments, the sole arrangement could alternatively allow for independent movement of inner sole sections, such as sole sections adjacent to and/or in contact with the user's foot (not shown), if desired, or the independently moving sole sections could be covered by an overlayer of flexible material (i.e., an over-sole or bootie).

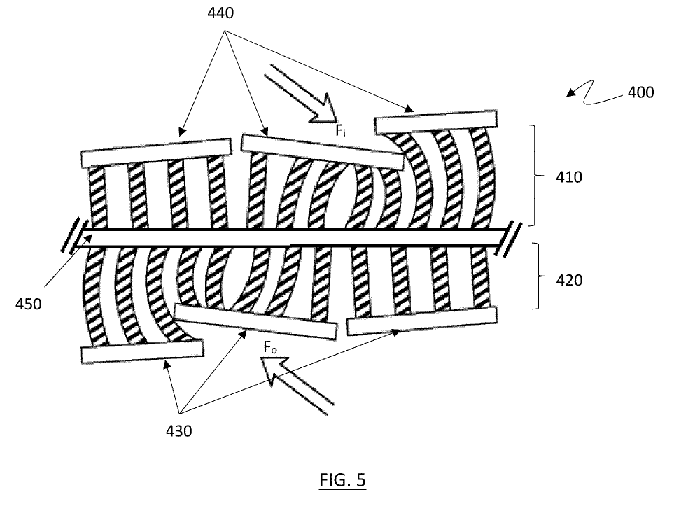

FIG. 5 depicts another alternative embodiment of a shoe sole 400, wherein the sole comprises an upper filament layer 410 and a lower filament layer 420. This sole includes an outer surface comprising a plurality of outer sole sections 430 (which in this embodiment are depicted as independently moveable relative to each other in response to an outer force Fₒ), as well as a plurality of inner sole sections 440 (which in this embodiment are similarly depicted as independently moveable relative to each other in response to an inner force Fᵢ). An intermediate layer 450 is provided between the upper and lower filament layers, which serves to anchor at least a portion of the filaments relative to each other, allowing each filament bed to independently compensate for forces acting thereupon. If desired, the intermediate layer 450 could comprise a substantially rigid material, or a more flexible material, or various combinations thereof (i.e., differing rigidity/flexibility in different regions of the intermediate layer).

In various embodiments, the outer layer can be relatively stiff, thereby preventing projections, rocks and/or debris from penetrating the sole and injuring the foot and/or damaging the filament layer(s). In other embodiments, the inner and/or outer layers could comprise a material pliable enough to locally deform. In some embodiments, the outer layer 105 can be at least five times more rigid than the inner layer. In some embodiments, the inner and/or outer layers may also comprise a plurality of deformable beams that are flexibly connected and arranged so that the longitudinal axes of the beams are substantially parallel to the surface of the inner/outer layer. Further, in some embodiments each of the deformable beams can be flexibly connected to at least one other deformable beam and at least one filament.

The filaments can comprise thin, columnar or elongated structures configured to deform non-linearly in response to an incident force on the shoe. Such structures can have a high aspect ratio, e.g., from 3:1 to 1000:1, from 4:1 to 1000:1, from 5:1 to 1000:1, from 100:1 to 1000:1, etc. In various embodiments, a non-linear deformation of the filaments would be desirable to provide the user's foot with improved cushioning and protection against high-impact direct forces, repetitive impact forces, point loading of foot structures and/or various lateral and/or oblique forces. More specifically, the filaments in one or more regions of the sole (and/or other shoe components) could desirably be configured to buckle in response to an incident force, where buckling may be characterized by a sudden “failure” or lateral (i.e., non-axial or non-longitudinal) motion of one or more filaments subjected to high compressive stress, where the actual compressive stress at the point of failure is less than the ultimate compressive stresses that the material is capable of withstanding. Desirably, the filaments will be configured to deform elastically, so that they substantially return to their initial configuration once the external force is removed.

At least a portion of the filaments can be configured to have a tensile strength so as to resist separation of an upper layer from a lower layer. For example, during lateral movement of the upper layer relative to the lower layer, some filaments having tensile strength may exert a force to counteract the lateral movement of the upper layer relative to the lower layer. In some embodiments, there may be wires, rubber bands, or other elements embedded in or otherwise coupled to the filaments in order to impart additional tensile strength.

As described in various locations herein, the various filament structures may be directly attached to the upper layer and/or directly attached to the lower layer. In some embodiments, at least some of the filaments can be free at one end, with an opposite end coupled to an adjacent surface. Due to the flexibility of the filaments, the upper layer will typically move laterally and/or anteriorly/posteriorly relative to the lower layer. In some embodiments, the filaments could optionally include a rotating member at one or both ends that is configured to rotatably fit within a corresponding socket in the upper and/or lower layers. In some embodiments, at least some of the filaments can be substantially perpendicular to the upper surface, the lower surface, and/or or both.

In the various IAS structures described herein, the filaments and/or other portions of the sole may comprise a variety of suitable materials, such as a foam, elastomeric material, polymeric material, or any combination thereof. In various embodiments, the filaments can be made of a shape memory material and/or a self-healing material. Furthermore, in some embodiments, the filaments may exhibit different shear characteristics in different directions.

In some embodiments, the lower portions of the shoe sole can be configured to deform locally and elastically in response to an incident force. In particular embodiments, for example, the shoe sole can be configured such that upon application of between about 100 and 500 static pounds of force, the bottom sole layer and potentially the interface layer may deform between about 0.05 to 0.10 or 0.10 to 0.25 or 0.25 to 0.75 inches. The deformability can be tuned by varying the composition, number, and configuration of the filaments, and by varying the composition and configuration of the upper layer and the lower layer.

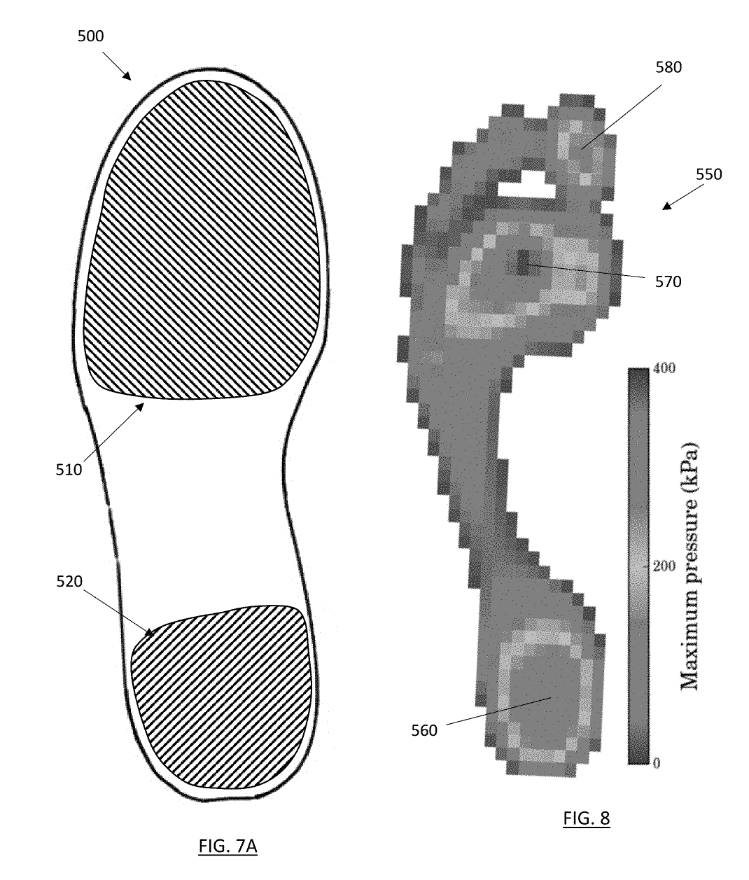

FIGS. 7A and 7B depict a top plan and perspective views of one exemplary embodiment of a left sole pattern 500, with a ball IAS insert 510 and a heel IAS insert 520 shown. This design is desirably arranged to provide impact management cushioning and force mitigation structures incorporating IAS features proximate to areas of peak force loads during walking and running activities. If desired, the inserts 510 and 520 could form a permanent part of the shoe sole, or the inserts 510 and 520 could possibly be removeable and/or customizable to the user's particular walking and/or running patterns.

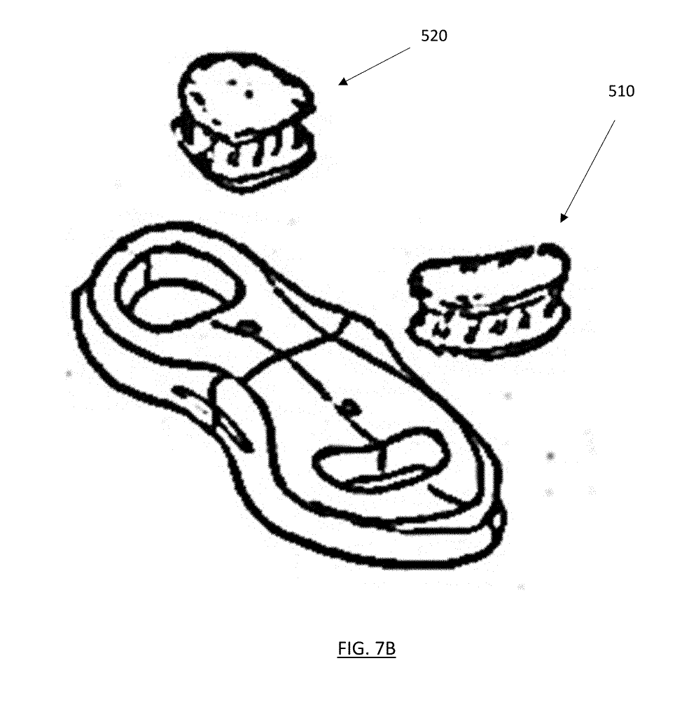

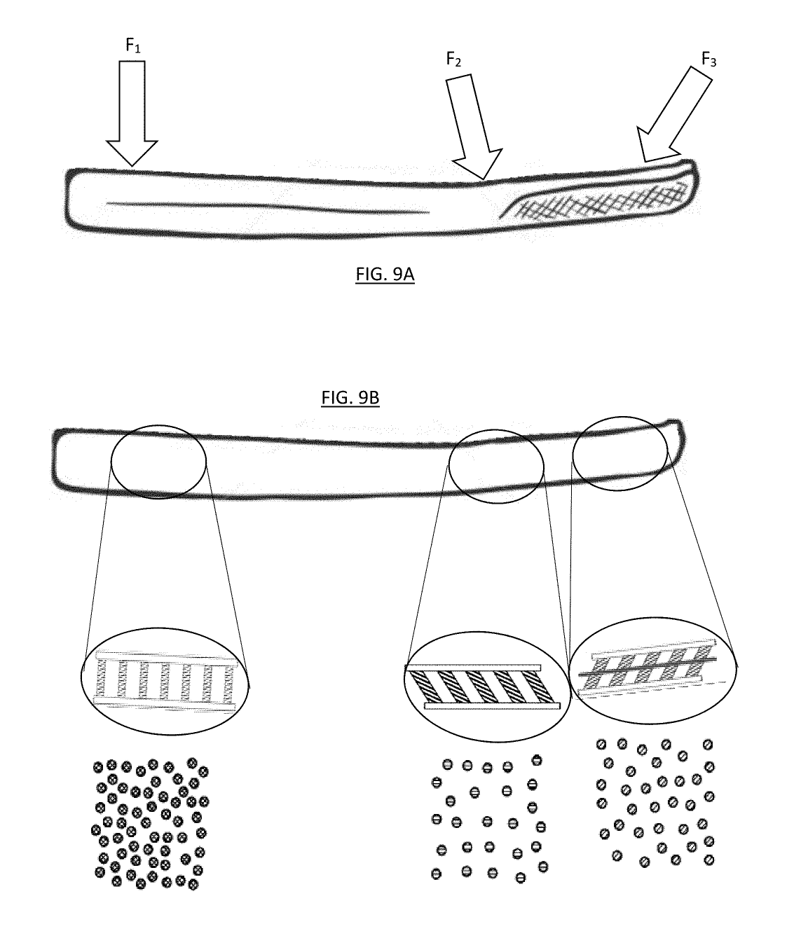

FIG. 8 depicts one exemplary pedobarographic mask 550 of pressure distribution in a typical foot during a single step. From this mask 550 it can be seen that significant foot loads are typically experienced at the center of the heel 560, at the ball of the foot 570 and at the base of the big toe 580, with lesser loads distributed at and/or around the remainder of the sole. These peak loads are distributed to the sole at different points during the step of the user, as shown in FIG. 6, with heel loading F₁ being generally more vertical (i.e., downward) in the center of the heel 560 (due to the initial contact of the foot with the ground), foot-ball loading F₂ angled slightly forward and downward in the ball of the foot (as the load shifts to the ball of the foot) and toe loading F₃ being angled towards the back of the foot for rolling of the foot and toe “push-off” at the end of the step. While in some embodiments each of these force loads might be accommodated by a single filament bed (i.e., incorporating buckling members of similar shapes and/or sizes under the entirety of the user's foot), in other embodiments a series of two, three, four or more filament beds (see FIGS. 9A and 9B) of different sizes, shapes, configurations and/or structural material(s) might be provided under differing locations of the foot, desirably to accommodate the various different types of loading experienced by the user's foot during various activities.

FIG. 10A shows a matrix 600 of generally cylindrical columns or filaments 610 made from an elastic material which could serve as components of an IAS. These columns may be fixed to a face sheet 620 on one end of the columns or on both ends of the columns, sandwiching the columns between 2 face sheets. The face sheets can desirably lie generally parallel to the planes of the foot bed and the sole, or the foot bed and the sole may serve as the face sheets if the columns are integrally formed in between these structures.

FIG. 10B depicts one alternative embodiment of a filament bed 700, wherein the impact absorbing structures therein can comprise long, thin columns 710, short thin columns having a first diameter 720 and short thin columns having a second diameter 730. Such an arrangement can potentially accommodate various impact forces with even more complex resistance, such that the IAS structures described herein could be particularized to respond to a wide variety of forces in a virtually unlimited manner. By altering the size, shape, number, concentration, material properties and/or boundary conditions (i.e., type and quality of connections, if any, to the face sheet or sheets) of the various column-like structures described herein, the impact resistance, surface distortion, energy absorption, deceleration, surface penetration (i.e., intrusion) and/or force distribution from the impact to nearby objects (i.e., the floor, the shoe components and/or the foot and related anatomy) can all be modified in a desired manner.

FIGS. 3D and 10A show exemplary filament beds of columns, some which of connect to both face sheets, and some of which only connect to one face sheet. This arrangement desirably provides the ability to reduce impact forces via buckling of some portion of the connected columns (which can also provide resistance via column compression before and/or after buckling), and then a second stage of impact reduction can occur as the non-connected columns impact the opposite face sheet and start to buckle. FIG. 3B depicts one exemplary image of a composite column structure (i.e., incorporating different sized and/or shaped columns into a single filament bed) when subjected to an impact force.

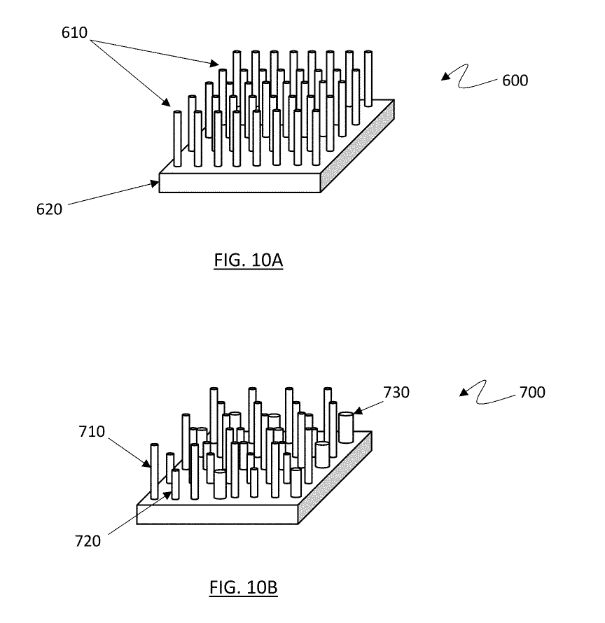

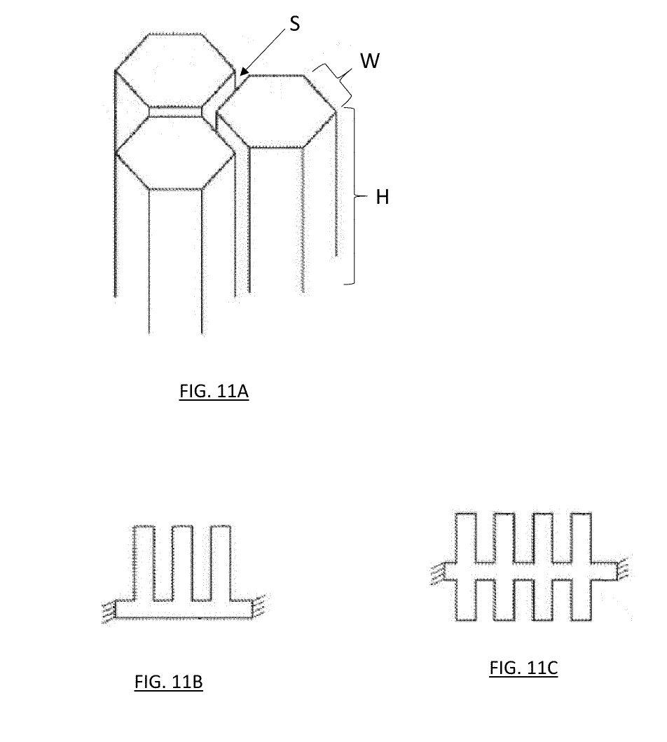

It should be understood that the impact absorbing structures disclosed in the various embodiments herein can be formed into a wide variety of shapes, sizes and configurations, each with their own impact absorbing and/or buckling characteristics, which allows a shoe designer to utilize a single material (if desired) to create numerous types of filament beds to accommodate a wide variety of impact forces. For example, the filaments in an IAS could be formed into a cylindrical shape, which could provide a first impact response. If desired, the cylindrical shape could be altered to a hexagonal cross-section (see FIG. 11A) having a column height H, a face width W and a column spacing S, with each dimensional change altering the impact response and/or buckling of the columns therein (see FIG. 26). If desired, other cross-sectional shapes could be utilized, including square, rectangular, oval, octagonal, complex and/or even freeform shapes could be utilized. In addition, FIGS. 11A through 11C show some varieties of column or filament construction, wherein the cross section of the columns may be other than cylindrical, and the columns may also be interrupted with other face sheets along the column's length.

Various embodiments of filaments can be configured for an interface layer (e.g., interface layer) of a shoe sole or other structure, in accordance with embodiments of the present technology. For example, a plurality of filaments having a cross-sectional shape of regular polygons can be utilized. Individual filaments may have a height, a width, and a spacing between adjacent filaments. If desired, filaments can be connected to an upper surface at one end, and can be free at an opposing end.

In FIG. 11C, filaments can be coupled to a spine at a middle point of the filaments, such that the filaments extend outwardly in opposite directions from the spine. If desired, the filaments can assume virtually any suitable shape, including cylinders, hexagons (inverse honeycomb), square, irregular polygons, and/or random forms.

If desired, the various constraints on the columns or filament could be altered in a variety of ways to modify the impact response of the IAS array. For example, one or both of the ends of the column(s) or filament(s) could optionally be secured to one or more face sheets, which could include complete constraint of the filament end to the face sheet as well as partial constraints (i.e., the filament is constrained in lateral movement but allowed to rotate relative to the face sheet, or is constrained in rotation but allowed to move laterally relative to the face sheet). By altering the boundary conditions of the filaments relative to the face sheets, the buckling response and/or impact response of the IAS can be significantly modified in a desired manner.

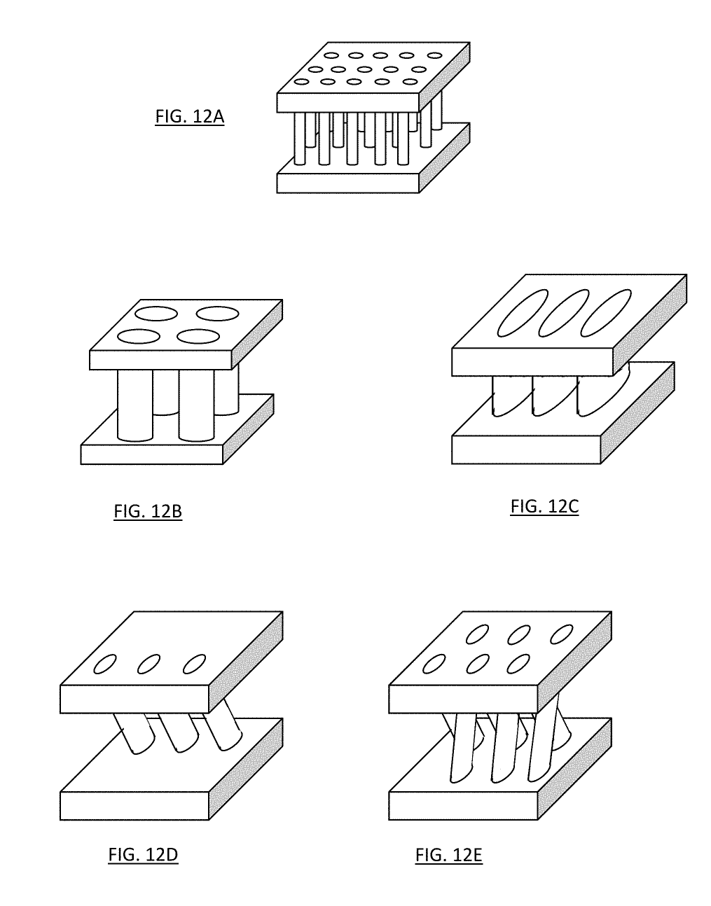

FIGS. 12A through 12E depict various alternative embodiments of IAS bed arrangements, each of which can potentially provide varying response to impact forces. For example, FIG. 12A depicts a dense network of densely spaced smaller diameter columns (which can be regularly or irregularly spaced, as desired), while FIG. 2B depicts a lower density network of larger diameter columns. FIG. 12C depicts a network of oval or elongate-shaped columns, which may deform and/or buckle in one or more desired directions, while FIGS. 12D and 12E depict networks of non-normal oriented (i.e., “tilted”) columns, which can be biased in directions other than normal to the face sheets (i.e., FIG. 12D showing filaments at an angle, and FIG. 12E shows sets of crossed filaments).

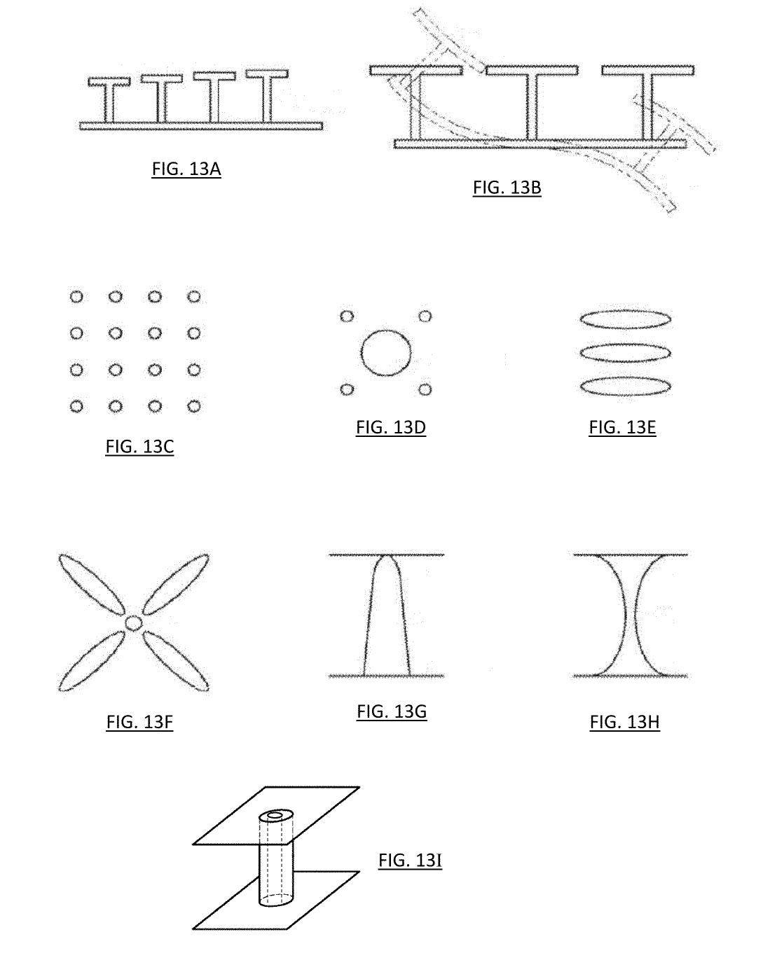

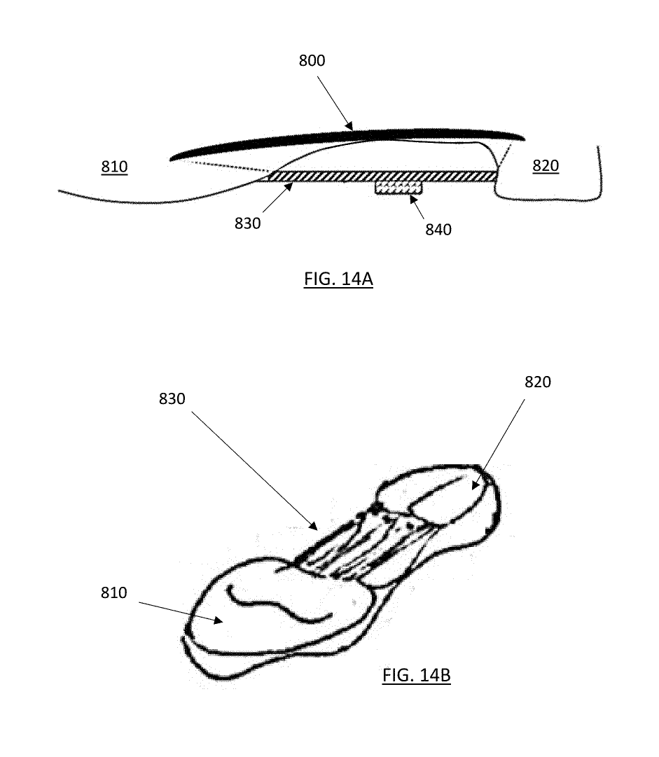

FIGS. 13A through 13I depict additional alternative embodiments of exemplary IAS filament arrays, including embodiments comprising a variety of column cross-sections and configurations. If desired, columns may differ along their diameter (i.e., they may be conical, frusto-conical, complex, hourglass-shaped, swab-shaped, etc.), and various filaments/columns may comprise different sizes, shapes, configurations and/or materials within a single filament bed and/or within a single piece of footwear, depending upon the impact absorption profile required in different parts of the shoe.

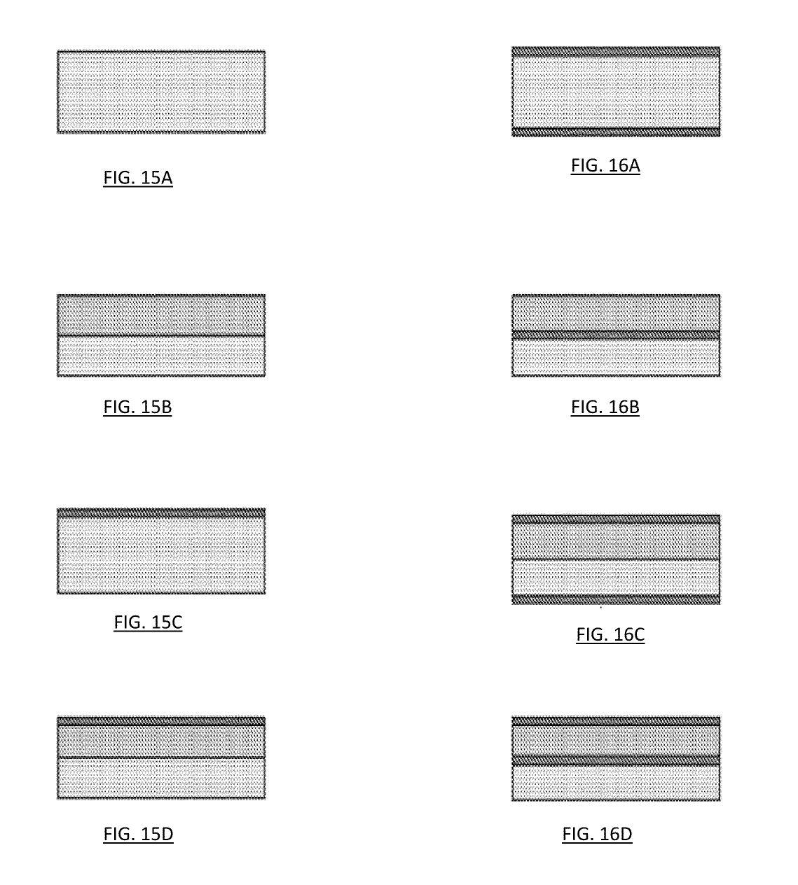

FIGS. 15A through 15D are cross section examples of various IAS configurations potentially useful in addressing impact forces as described herein. In various embodiments, the IAS configuration may be oriented as shown (with the foot proximate the top of the structure and the floor or contact surface proximate the bottom of the structure), or the structure could be inverted in use (i.e., with the foot proximate the bottom of the structure as depicted in the figures, and the floor or other contact surface proximate the top of the structure in the figure), or any angle or variation thereof. FIG. 15A depicts a single IAS layer with a same density throughout. FIG. 15B depicts a multiple IAS layer (which may include one or more layers of foam or other currently existing impact absorbing materials) with multiple densities of IAS arrays or matrices. FIG. 15C depicts a single IAS layer with a solid, semi solid and/or partially flexible outer/inner solid layer. FIG. 15D depicts multiple IAS layers of differing density with an outer/inner solid layer.

FIGS. 16A through 16D are exemplary cross sectional depictions of various solutions to design protective footwear and/or other clothing (i.e., hard or soft goods) incorporating IAS arrays. Many of these solutions can involve combining any combination or single layer of foam, inflatable air and/or liquid bladders, flexible and/or elastic materials and/or other materials with the various IAS layers depicted herein, including those shown in FIGS. 16A through 16. For example, FIG. 16A depicts an IAS layer with one layer or multiple layers of solid material surrounding the IAS filaments. In this embodiment, the solid layer or layers desirably help to distribute impact loads into the impact absorbing structure to create a larger area of the absorbing material than just the area which is struck and/or otherwise directly affected by an impact. In each figure, the IAS or solid layers shown by different shading can either be similar to each other or different in size, shape, structure or material. Likewise, structures shown in each figure in the same shades could (but not necessarily are) either be similar to each other or different in size, shape, structure and/or material.

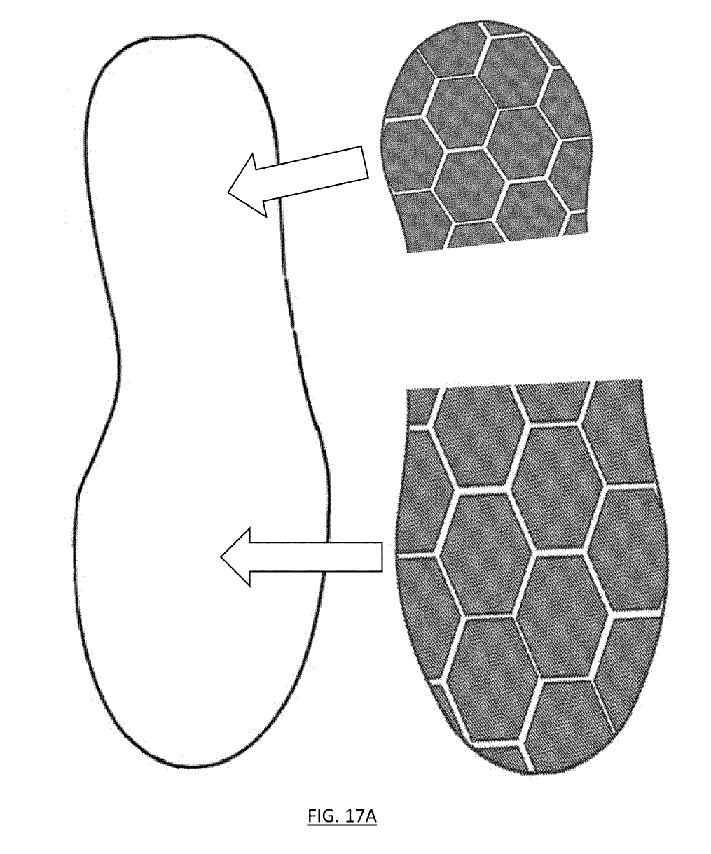

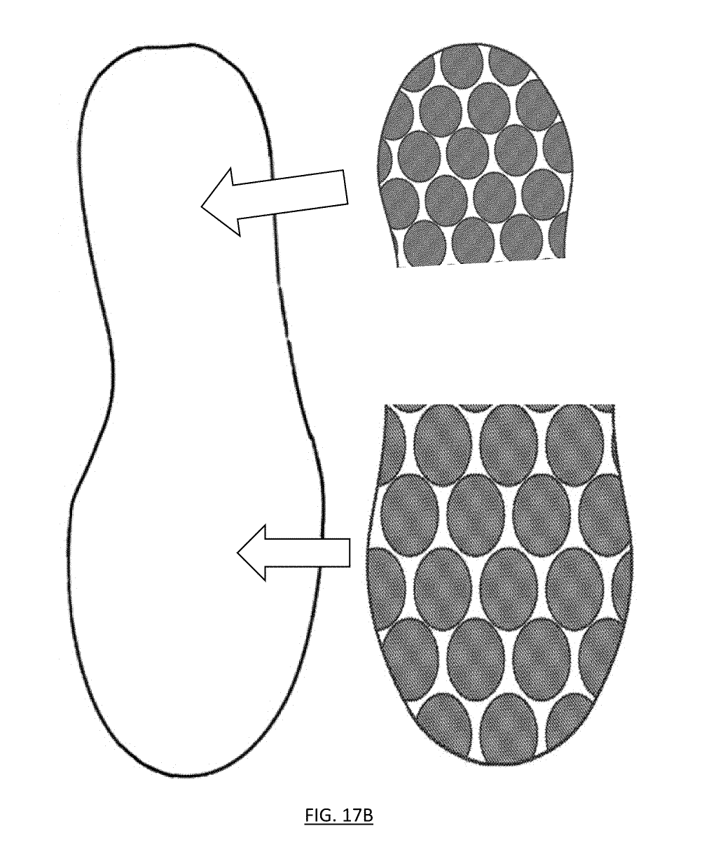

As previously noted, FIG. 16A depicts an IAS web or mesh material having a solid or semi-solid layer on both the inner and outer surfaces. FIG. 16B depicts a solid or semi-solid layer in between two IAS layers. FIG. 16C depicts multiple IAS layers, with a solid layer is on both the inner and outer surfaces. FIG. 16D depicts multiple IAS layers, with a solid layer on the outer surface and another solid or semi-solid surface between them. In various embodiments, the “solid” layer could be a layer of relatively more rigid and/or denser material that can distribute an impact load to a larger surface of the IAS, and/or could be a more durable surface for abrasion and/or impact resistance (i.e., the bottom of a shoe sole). If desired, the “solid” layer could comprise multiple pieces that are nested or grouped together to allow for the layer to flex and take shape with the contact surface and/or user, as desired. FIGS. 17A and 17B depict two examples of how solid or semi-solid layers could be integrated into shoe designs within the system. These individual pieces of each IAS web could incorporate virtually any shape, and need not necessarily be repeating the same shape as they may be designed to allow for more or less flexibility in different areas of the product. In addition, various embodiment may allow the pieces to overlap in a manner similar to scale armor or armadillo skin plates, and the individual components need not necessarily be spaced uniformly or in any particular manner except as desired.

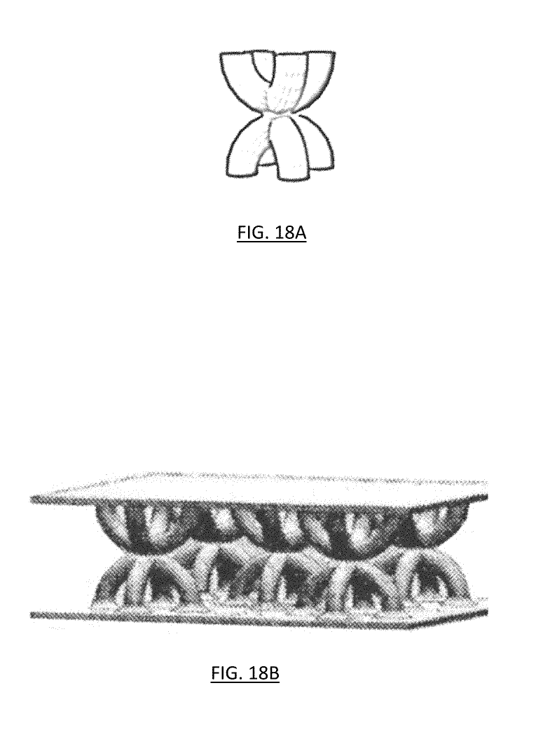

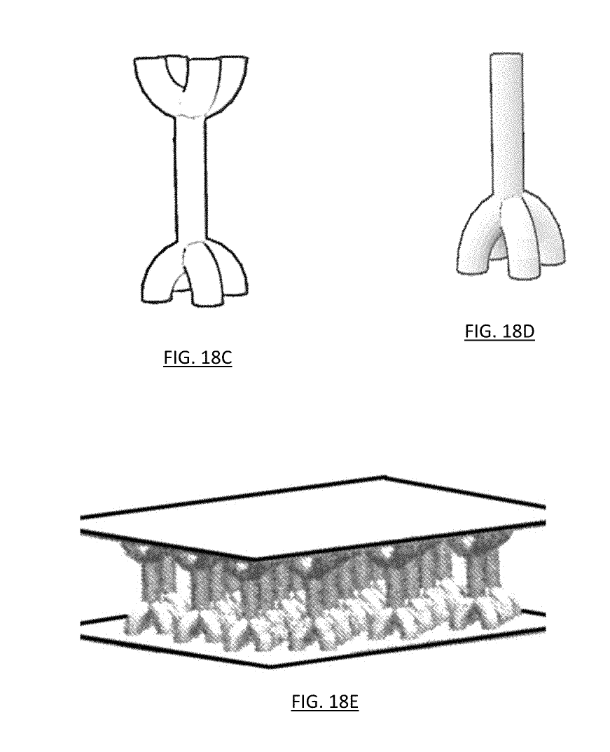

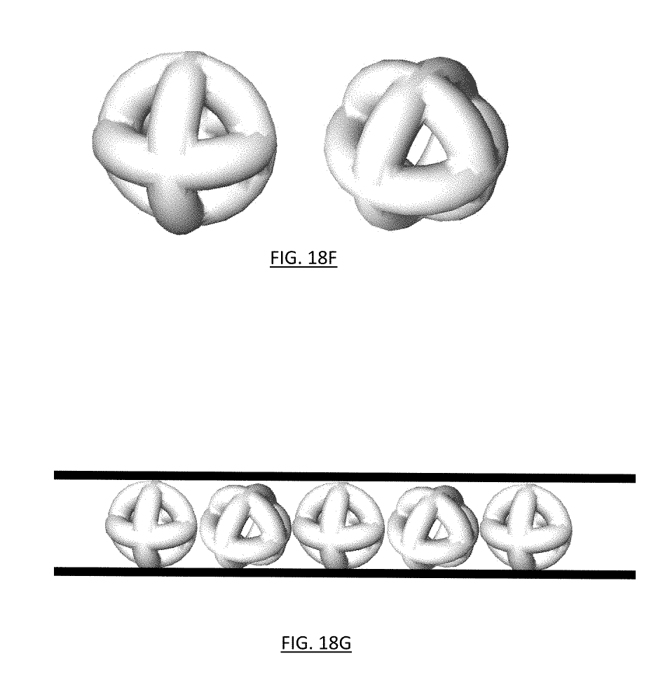

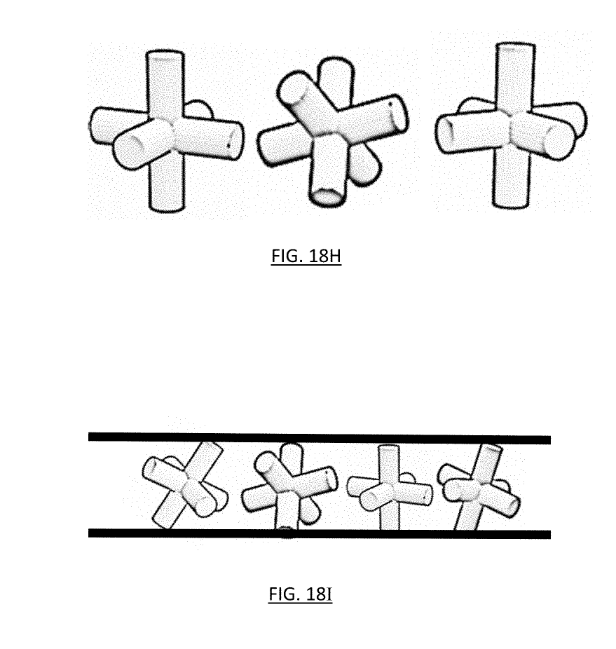

FIGS. 18A though 18I depict various alternative embodiments of IAS structures that could be incorporated into various shoe and footwear components, including placement between the foot bed and sole, to reduce transmission of impact forces and/or improve shoe performance in a variety of ways.

Venting

One potential significant advantage of incorporating IAS and/or similar arrays in the management of impact loading in shoes is that ability of certain buckling structure designs to accommodate the free passage of air, water, sweat and/or air vapor through and/or within the IAS array without significantly affecting its utility. In fact, in certain array designs, impact absorbing structures can be designed that actively “pump” and/or otherwise transfer sweat and/or water vapor away from a user's feet, and may also provide fresh air to various regions of a user's feet. For example, the buckling structure depicted in FIG. 13I can incorporate a central lumen, which can be in fluid communication with a corresponding opening formed through the insole of the shoe, with the central lumen similarly in communication with one or more openings in the bottom and/or sides of the of the shoe (with a plurality of such structures forming an IAS array corresponding to multiple perforations in the insole). During use (i.e., running, jogging and/or athletic activity), the user can step on the IAS array in the shoe, which will likely buckle and compress or collapse some of the hollow filaments, causing air and/or other materials within those filaments to potentially travel towards the foot and/or outwards from the shoe. Once the user's foot lifts off from the ground (and consequently off from the IAS array), the filaments will desirably rebound and assume an unbuckled and/or uncompressed condition, potentially drawing air and/or fluids away from the user's foot and/or drawing fresh air into the shoe structure. Repeated steps will desirably evacuate unwanted air and/or fluids, which could be augmented by the incorporation of biasing structures such as one-way valves and/or other arrangement to facilitate the resulting “pumping” action in a desired manner.

In various alternative embodiment, the insole could comprise an “open sole” construction, wherein the upper portion of the buckling structures might be in direct contact with the user's foot, which could include the absence of an upper face sheet (or potentially only the presence of a perforated and/or air/water/vapor permeable upper face sheet), possibly allowing air within and/or between the various buckling structures venting structures to “bathe” the user's foot and/or sole with fresh air and/or remove moisture and/or sweat from foot areas. In drier climates, this removal and pumping action might have the added benefit of providing some level of evaporative cooling to the user's feet and/or leg regions, which would be an extremely desirable feature for a wide variety of athletes and/or competitive runners.

Modification, Customization and Performance Enhancement

A variety of potential benefits conferred by the incorporation of buckling structures and other IAS array designs into athletic shoe and/or other footwear designs is the ability to “tune” or otherwise modify the “response” of the impact absorbing structures in unique ways as compared to the traditional methods of selecting different foam materials and/or material combinations for shoe soles. Because IAS structures can easily provide non-linear responses to impact loading, and because IAS structures can be designed to respond in different manners due to variations in the speed, intensity, magnitude and/or directionality of impact loads, it is now become possible to design athletic footwear that independently optimizes its performance for various athletic activities. For instance, IAS structures can be incorporated into basketball shoes that maximize energy return and/or present a stiffer sole to a player's feet when he or she takes a jump shot to shoot a basketball into the hoop, but the same structures can instantly “shift” to a “softer” sole that maximizes energy absorption when the player lands from the jump shot. Moreover, the same structures can potentially provide enhanced lateral and/or shear stability for the player's feet and ankles as they are “cutting” and/or dribbling the ball down the court, without sacrificing other repetitive impact loading advantages.

If desired, IAS arrays and buckling structures can incorporate structures and/or materials that could be “rate sensitive” and/or “directionally sensitive,” including materials that may “harden” or otherwise modify their properties under stress and/or strain. Such materials could be provided in some embodiments to surround filament structures, while in other embodiments such materials could be contained within the filaments (i.e., a filament having a hollow core) and/or could be incorporated into the filament materials themselves.

In various embodiments, filaments and other buckling structures within an IAS array (or the array itself) could incorporate one or more of the following to alter and/or tune the properties of the array: (1) magnetic and/or ferrous fluids surrounding and/or internal to the buckling structures (to desirably allow altering of the buckling properties), (2) magnetic particles incorporated into the various polymers used in forming the buckling members, (3) piezoelectric materials incorporated into and/or adjacent to buckling structures to desirably create electricity and/or alter materials/adjacent fluids, (4) rate sensitive materials to alter buckling performance and/or protect anatomical structures (i.e., steel toe-like materials that are normally soft and pliable), (5) structures that can include separated regions, with each region tunable to different characteristics, (6) buckling structures that are contained within a collapsible “bag” or tube, which in some embodiments can be pressurized and/or evacuated, and/or (7) metallic or rubberized buckling structures—i.e., buckling springs designed similarly to IBM's buckling keyboard spring design.

In addition, the point(s) of connection between filaments and the surrounding surfaces and/or internal spines, the dimensions, the filament material(s) and the material(s) in the space between the filaments can all be optionally modified to tune the orthotropic properties of the filaments. This tunability is expected to provide desired deformation properties and can be varied between different regions of the interface layer. Filaments can be made from materials that allow large elastic deformations including, for example, foams, elastic foams, plastics, etc. The spacing between filaments can be filled with gas, liquid, or complex fluids, to further tune overall structure material properties. In some embodiments, for example, the space can be filled with a gas, a liquid (e.g., a shear thinning or shear thickening liquid), a gel (e.g., a shear thinning or shear thickening gel), a foam, a polymeric material, or any combinations thereof.

In a similar manner, IAS arrays can be employed to design a shoe that performs in different manners during different sports, which might incorporate automated or semi-automated selectable “switching” functions (i.e., the IAS independently could accommodate different loading patterns experienced in each sport) or which might incorporate user-selectable features that enable to user to alter shoe performance as they desire. For example, a shoe design incorporating IAS arrays could accommodate the constant, repetitive compression experienced by a runner's feet, but the IAS arrays therein could perform differently when the user played basketball (i.e., to accommodate the jumping, quick lateral movements and acceleration and/or deceleration required of the game's players). The same shoe design might further be capable of modification to accommodate the athletic demands of hockey players or other sports, either automatically or with the “click of a button” by the user.

In various embodiments, the various advantages described herein could be further augmented with user-selectable features that desirably allow a user to “personalize” and/or otherwise modify the performance of their footwear in a desired manner. For example, a shoe incorporating the impact absorbing structures described herein could similarly incorporate a longitudinally extending tension or compression band connected between the heel and toe regions to adjust/improve flexing of the shoe for energy collection and/or dissipation at a desired moment (i.e., a “leaf spring” energy storage/return system for shoes).

FIGS. 14A and 14B depict one exemplary embodiment of an adjustable energy absorption/return shoe system, where the shoe includes a metal, polymer or ceramic “strip” 800 that extends between a toe region 810 and a heel region 820 of the shoe, and which is also connected to an adjustable tension/compression band 830 also extending between the toe and heel regions. In use, a control knob 840 or other system could allow the user to alter the response of the tension/compression band, which could thereby alter the response of the shoe in a desired manner. In various alternative embodiments, a similar system could incorporate the metal strip in the heel as the “base” of the leaf spring, which could optionally be directly attached to one or both sides of the band. If desired, a tension band (or bands) could be pre-loaded by the manufacturer to accommodate a specific size, weight and/or athletic style of a user (see FIG. 14B), or the one or more bands could be user-adjustable (including adjustability of individual bands on the right and left sides of a single shoe to allow differential tension across a single sole), to accommodate a variety of athletic activities.

In other alternative embodiments, the tension/compression, buckling and/or IAS arrays (or individual structures thereof) could be positioned in other directions, include cross-ways and/or side-ways in the shoe, as well as virtually any angle relative thereof, with potentially considerable variation in orientation between even the individual filaments within a single IAS array.

In various alternative embodiment, IAS arrays and/or buckling structures could be incorporated within a contained space or “bag” in which a material, fluid and/or air surrounding the buckling structures could be modified (i.e., increased or decreased in pressure using a detachable or attached pump or other device), which may have the added benefit of potentially modifying the impact absorption response of the buckling structures themselves. For example, where buckling structures might comprise a closed-cell foam material, an increase in the localized air or liquid pressure (i.e., by “pumping up” the pressure in the bag) might alter the shape and/or size of the buckling structures themselves (i.e., the increased surrounding pressure might cause the foam buckling structure to shrink in diameter, thereby altering its physical response to impact loading), which could potentially reduce the compression resistance of the overall IAS array, even though the pressure inside of the bag might have been increased.

If desired, a shoe design could include one or more “swappable” inserts or similar structures incorporating IAS arrays that could allow a user to quickly and/or conveniently modify the performance of a single pair of shoes. For example, a removable “heel insert” or similar structure could be provided that could be exchanged for other heel inserts having different IAS arrays and impact response, which could be swapped out for different activities. In various other embodiment, swappable inserts could include sensors to measure and/or record performance and/or gait dynamics/mechanics, which could potentially be monitored in various ways.

Medical Treatment Applications

In various embodiments, IAS arrays and/or buckling structures could be incorporated into footwear and/or other lower extremity protection devices to accommodate, ameliorate and/or correct various medical conditions, as well as potentially prevent or delay the onset of various medical conditions not currently addressed by adequate footwear designs. For example, a sneaker, shoe, boot or other footwear (including, but not limited to, braces, wraps and/or casts), could incorporate one or more IAS arrays that are particularized for a specific individual's walking/running patterns and/or gait. If desired, the shoe could be designed to accommodate a person's gait, or a shoe could be designed to correct or “train” the user to assume a more “normal” gait (with “normal” typically defined as a gait that produces less tissue or bone damage than currently experienced by the user and/or which more closely approximates an average or healthy gait for the individual). The shoe may include IAS matrices or other structures that accommodate or correct the user's gait (i.e., IAS arrays and/or structures that correct for over-heel running), as well as shoes that reduce stiffness and/or foot pressure in “hot spot” areas of the user's foot.

In various embodiments, IAS arrays and/or buckling structures could be utilized to provide added support and/or protection for a user's feet in non-utilitarian or “fashion” footwear, such as in high heels and/or cowboy boots. The ability of such structures to provide significant impact protection in small areas may be particular useful in such applications, because IAS arrays could be placed in unobtrusive locations (i.e., under the arch and/or ball of the foot in high heels or in the pointed toe of the cowboy boot) to provide added support and/or comfort without sacrificing the natural “look” of the footwear.

Sensor Systems

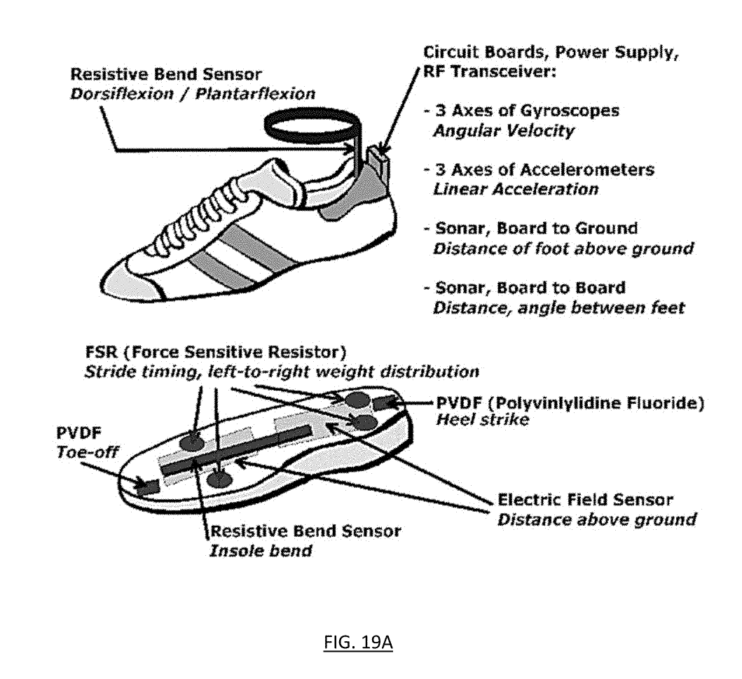

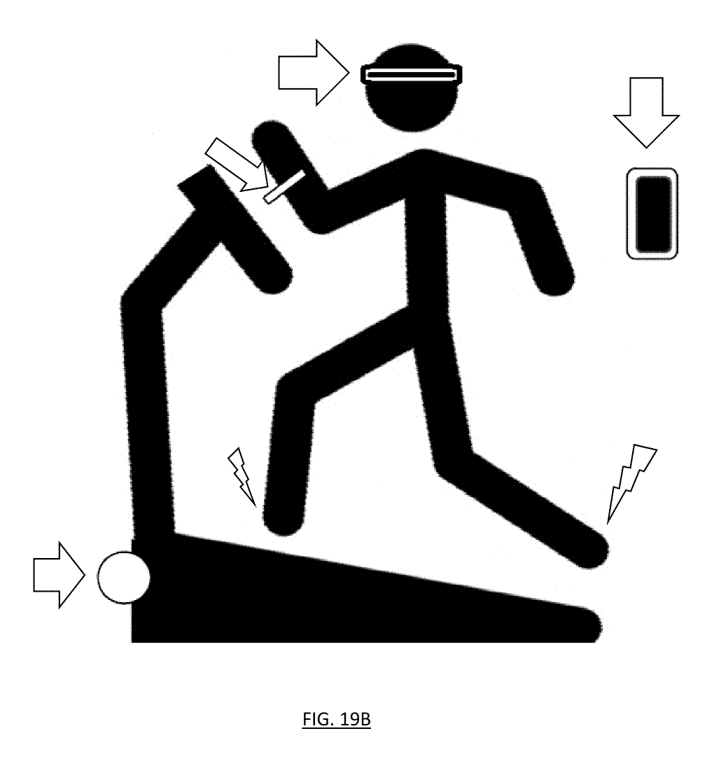

If desired, the IAS could incorporate sensors that sense, read and/or record a user's gait, or a removable sensor system or external sensor system could be used. For example, FIG. 19A discloses a sensor system potentially useful in recording the shoe activity of a user, wherein sensors are contained between two 0.02 inch sheets of clear Type 1 PVC (polyvinyl chloride) heavy-duty film sheets. In this embodiment, four FSR pads (force sensitive resistors that measure continuous pressure), two PVDF strips (polyvinylidine fluoride, a piezoelectric material that measures dynamic pressure), and two pairs of resistive bend sensors can provide a measurement of the pressure distribution beneath the foot, and are placed with two beneath the heel (medially and laterally) and two located forward, behind the toes (one beneath the first metatarsal head, and another beneath the fourth and fifth metatarsal head). The PVDF strips can desirably provide dynamic information about “heel strike” and “toe off,” and can be located beneath the heel and the beneath the hallux (big toe). Each pair of bend sensors can provide information about bi-directional bend (each pair consists of two bend sensors which are placed back to back). One pair can provide information about the extent of plantarflexion or dorsiflexion at the ankle, which could be located at the back of the shoe and/or inserted into a collar or ankle strap so that it bends around the rear edge of the shoe as the ankle tilts. Another pair of bend sensors can provide information about the extent of plantarflexion or dorsiflexion at the metatarsals during walking, and could thus be located at the forward portion of the insole.

As best shown in FIG. 19B, a sensor system contained within a shoe or shoes could potentially collect use data (i.e., real-time and/or stored data), which in various embodiments could be transmitted or uploaded via Bluetooth or other wireless (or wired) technology to a smart phone, smart watch, headband-based computer or sensor array, exercise equipment with installed data readers and/or personal fitness tracking device (i.e., Fitbit™) for analysis and/or use. Such data could be utilized to identify misaligned gait and/or “hot spots” for particular users, as well as to create structures that correct and/or accommodate a misaligned gait. If desired, onboard shoe IAS arrays incorporating modifiable features could be activated by an external and/or internal computing device or monitor to actuate changes to the localized stiffness or other performance of the IAS array of the wearer's shoe in the region of hot spots or could alter to address and correct gait malalignment and/or improve athletic performance—functions which might be performed automatically and/or manually with user input.

Energy Harvesting

If desired, IAS arrays and/or buckling structures could be incorporated within various shoe structures and/or shoe components to generate and/or harvest energy for use in powering various devices and/or components. For example, IAS arrays and/other buckling structures in a shoe design could incorporate piezoelectric beams or other energy generating structures in some or all of the array, with the buckling and/or stretching of the beams during movement generating such energy in a known manner of movement and beam deformation. Where the piezoelectric beams formed only a portion of the IAS array, the remaining filaments therein could provide particularized impact absorption and/or resistance as described herein. If desired, the energy created by the beam deformation could be utilized to power various devices within the shoe (i.e., to provide communication with external devices, provide internal computer processing power and/or to modify IAS performance) and/or energy could be stored (i.e., within a “shoe battery”) and/or the shoe could be linked with external devices (i.e., using a USB or other-type connection) to provide external power to other devices.

Bony Structures and Bone Spurs

In various embodiments, it may be particularly useful to incorporate IAS arrays and/or buckling structures in sole structures proximate to underlying bony structures and/or near “bone spurs” of a patient's foot. For example, IAS arrays might be best suited proximate to the foot bones (i.e., the bottom of the calcaneus/talus, near the ankle, proximate to the ball of the foot and/or under the toes of the user, with traditional cushioning materials (i.e., polymer foams, fabrics, leathers) utilized for support and/or impact absorption in other areas of the shoe sole. Alternatively, IAS arrays might be best suited proximate to soft tissue structures of the foot, depending upon user need and the shoe designer's intent.

Shock Sock

FIGS. 20A and 20B depict exemplary ways in which IAS arrays and/or buckling structures might be incorporated into fabric and/or highly flexible structures such as tapes or wraps, which could provide added comfort and/or shock absorption ability. Unlike traditional foams and/or other shock absorbing materials, IAS arrays and/or buckling structures can be designed from durable and/or washable materials (potentially including the same material from which the sock itself is constructed), which can often retain their performance enhancing properties throughout hundreds of washing cycles. Accordingly, a fully flexible sock or “shock-sock” (FIG. 20A) or flexible shoe insert (FIG. 20B) can be created, which could be utilized with existing shoe technology, if desired.

Composite IAS Arrays

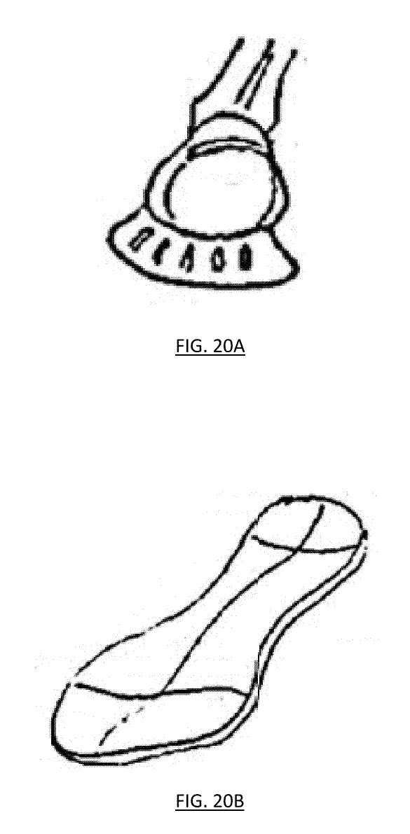

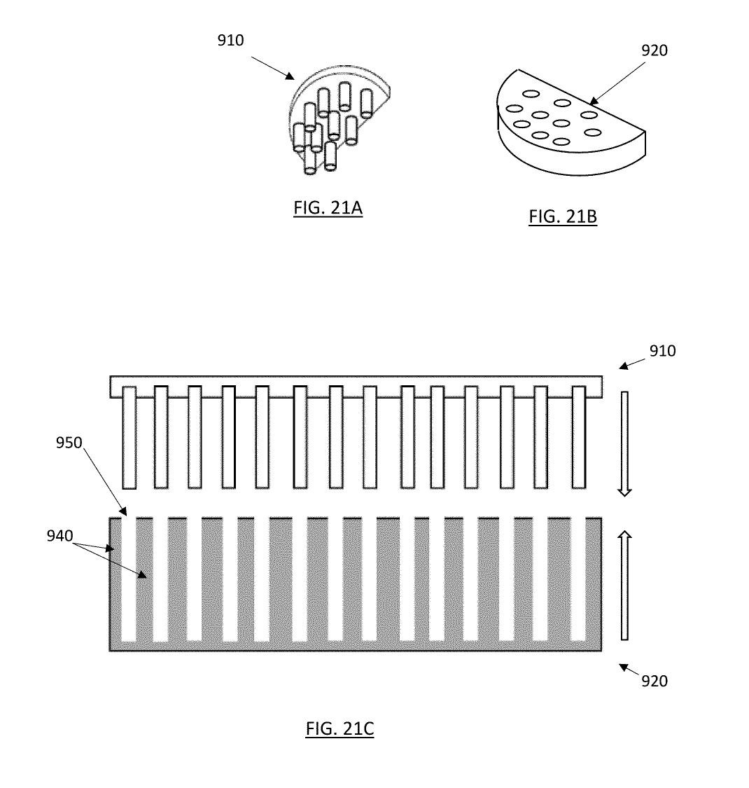

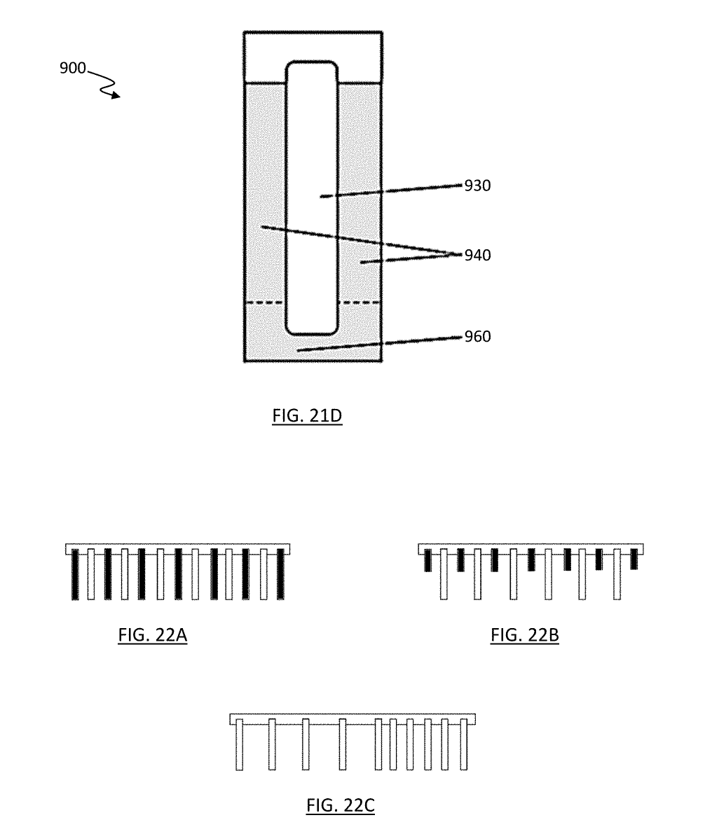

In various embodiments, a multi-component or “composite” IAS array system could be provided that allows a potential user to select from a variety of individual elements that, when combined together, create an insert or other shoe component having unique performance features to suit the user's needs. Such “composite array” systems can include a limited number of components that can be “mixed and matched” in a variety of ways. For example, FIGS. 21A and 21B depict two possible components of a composite IAS array 900, comprising an upper component 910 and a lower component 920, which when combined together can create a composite heel component 900 for insertion upward, downward and/or sideward into a “heel void” provided in an athletic sneaker (not shown).

As best seen in FIGS. 21C and 21D, one embodiment of a composite IAS array 900 can comprise an upper component having a top face 920 and a plurality of buckling structures 930 extending downward therefore. The lower component can include a body 940 having a plurality of voids 950, with each void 950 facing upward and desirably corresponding to a buckling structure 930. When the upper and lower components are combined together, such as shown in FIG. 21D, the array 900 will desirably include a buckling structure 930 encased in within the lower component void 950 (with the body 940 potentially fitting tightly around the buckling structure and/or may be a looser fit with gaps around the structure). In this embodiment, a distal tip of the structure can fit within and engages with a lower face sheet of higher density foam 960 to better secure the lower end of the buckling structure in a desired manner. FIGS. 22A through 22C depict alternative upper components that could be provided with the single lower component to alter the heel insert performance as desired. The lower insert of FIG. 22A could include buckling structures of differing shapes and/or densities, while the lower insert of FIG. 22B could include shorter, more rigid columns to provide additional shear resistance in certain designs. If desired, the lower insert of FIG. 22C could include a reduced number of buckling structures, with some voids in the lower component left unfiled when the upper component is mated thereto. If desired, the distal ends of the buckling structures could be tapered to more easily fit within the voids of the lower component.

In various embodiment, the lower component could comprise a “block” of foam or other material having multiple holes or tubes facing upward formed therein, with the upper structure comprising a series of filaments or columns facing downward (like a comb or hairbrush). At the user's option, sliding the two structures together could create composite structure with unique compression/buckling characteristics. Different materials and structural sizes/shapes could produce different linear and/or non-linear response curves (and combinations thereof, if desired), and the individual components could potentially be utilized individually (i.e., even used without being mated to the opposing component), or combined with other components as desired. Moreover, in various embodiments a lower density foam section(s) in the lower component could include regions of lower/higher density or stiffness to direct buckling in a desired direction (i.e., higher density foam could be positioned on left of a column with lower density foam on the right of the same column, such that the column preferentially buckles to the right side. If desired, different densities on differing sides of the column(s) and/or along the length of a column could similarly be provided.

Shear Loading

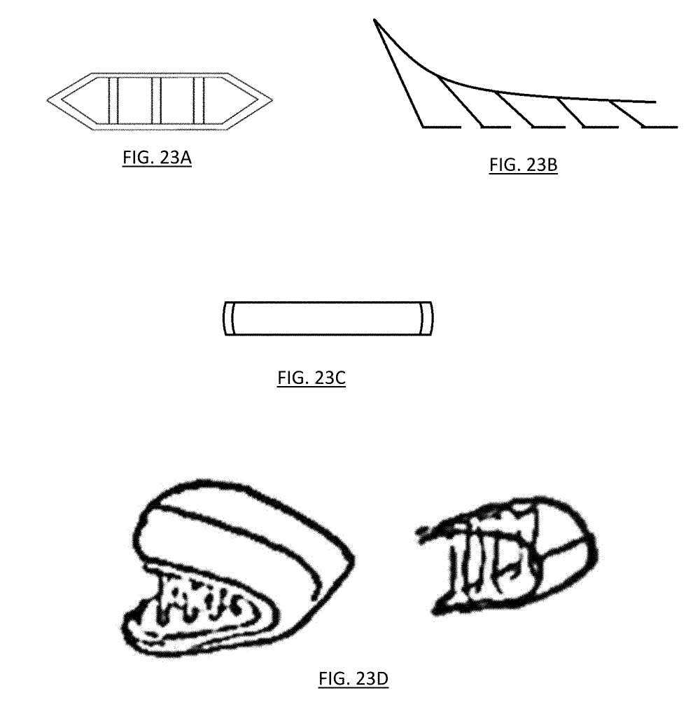

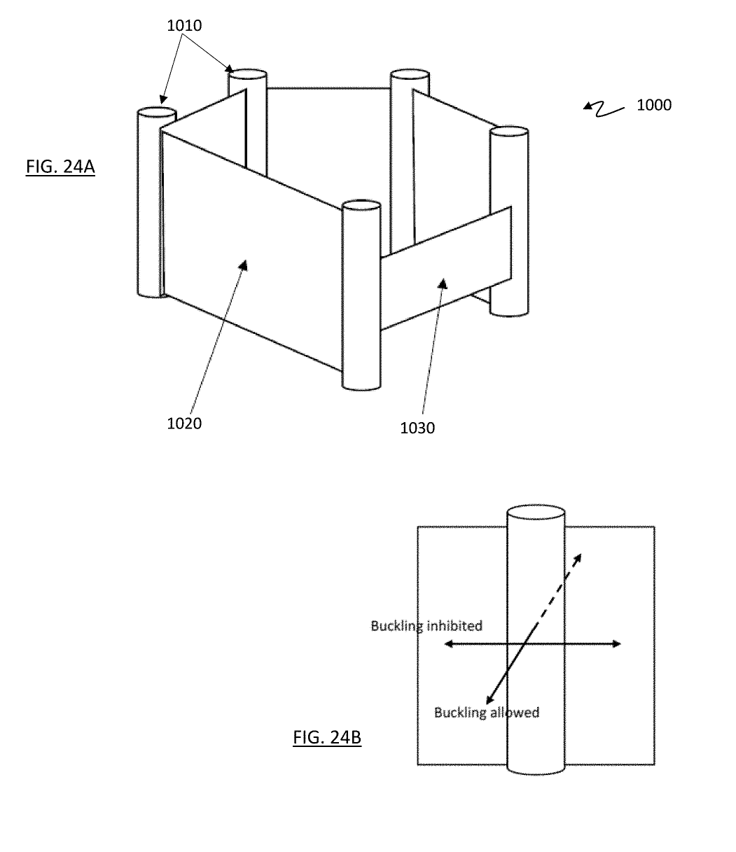

In various embodiments, IAS arrays and/or buckling structures can include various features to address lateral or shear loading of the array/structure in a desired manner. For example, an IAS array can include external or boundary walls or similar features that absorb and/or otherwise resist lateral loading of the filament array (see FIGS. 23A through 23D), or internal walls and/or filament arrangements absorb and/or otherwise resist lateral loading applied thereto (see FIG. 23B). FIG. 25B depicts another alternative embodiment of a sole design incorporating one or more IAS arrays, wherein the central region of the sole comprises a flexible “trampoline bed,” with pre-buckled filaments around the perimeter of the sole, and peripheral openings to allow air to leave and enter the sole during compression/relaxation.

If desired, IAS or boundary structures could be provided that inhibit lateral deflection in some areas, potentially allowing deflection in other areas and/or directions. For example, one exemplary shoe design could include a solid or semi-solid connection in the arch of the sole to inhibit side-to-side and/or lateral motion of heel structures, while allowing significant vertical deflection and buckling to accommodate the heel strike of the shoe. If desired, a v-shaped or c-shaped insert (see FIG. 23D) located proximate the heel could accommodate vertical loading, while desirably limiting the effects of shear and/or rotational loading on the buckling structures. If desired, the heel (or other locations) could include or be contained by boundary walls and/or other structures (i.e., internal and/or external to the “buckling array”) that could accommodate some or all shear/lateral forces in an outer region, while a central region could more easily buckle to accommodate vertical impacts. In a similar manner, lateral force resistance could be accomplished by appropriate filament design, which could include boundary walls and/or internal restraint webs that resist shear in one or more directions, while allowing buckling in other loading mode(s).

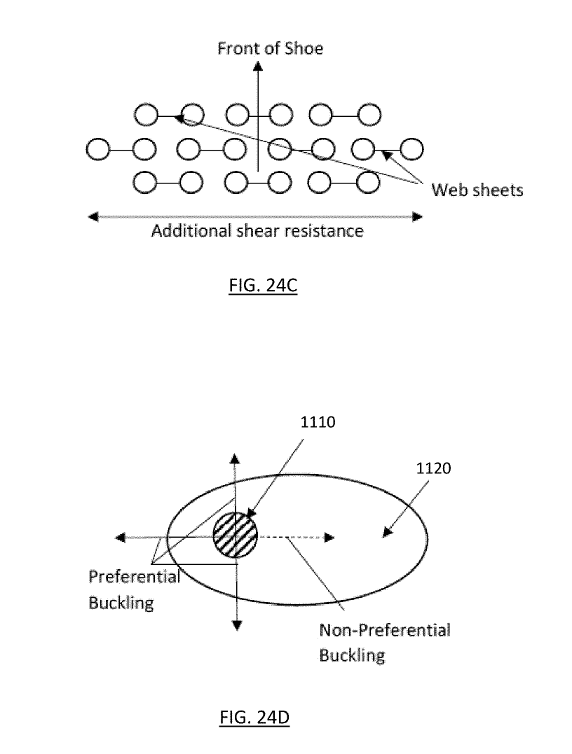

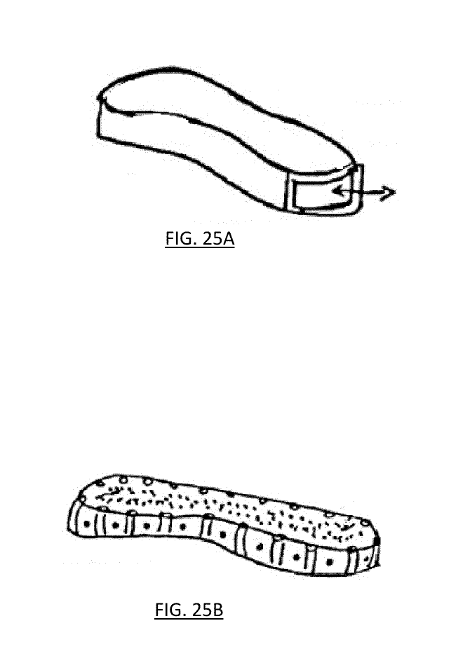

If desired, the IAS array and/or buckling structures within the array could incorporate a variety of boundary or “control” arrangements to prevent and/or inhibit buckling and/or other deformation in one or more directions or modes. For example, FIG. 24A depicts an IAS array 1000 incorporating a plurality of filaments 1010 connected by sheets 1020 and/or tension bands 1030 therebetween. In this embodiment, the filaments are desirably inhibited from buckling in certain directions, while allowed to buckle freely in other directions (see FIG. 24B). While tension bands and/or sheets are depicted in this embodiment, other similar arrangements are possible, including bands or sheets capable of withstanding compressive loading (i.e., by thickening the band, for example). In addition, the sheets and/or tension bands could be “raised” or “lowered” relative to the upper and/or lower face sheets (and need not be centrally located along the filament), further modifying buckling resistance to achieve a desired impact force response. The sheets/bands and similar structure(s) could also be angled, if desired (i.e., connecting a midpoint of one buckling structure to a lower half of an adjacent buckling structure, or the like). FIG. 24C depicts a top plan view of one potential IAS array incorporating a sheet connection arrangement desirably suitable for resisting lateral shear forces to some degree.

FIG. 24D depicts an alternative arrangement for constraining the buckling response of filaments in a desired manner, in which thicker and/or higher density foam or other material surrounds a buckling structure, desirably inducing the buckling structure to “fail” or otherwise buckle in one or more preferential directions. In this embodiment, the buckling structure 1110 can be surrounded by a foam 1120 or outer column structure (which might incorporate a rate sensitive liquid, in various embodiments). This surrounding structure could desirably resist and/or impeded buckling of the structure in various directions, while allowing or promoting buckling in others.

Shoe Skins

In various embodiments, shoe designs are contemplated that incorporate one or more IAS arrays in a sole and/or other shoe component, with a plurality of removeable and/or replaceable “skins” or surface treatments that can be applied to the sole to facilitate alteration of the look, feel and/or functions of the shoe for different activities. In this embodiment, the shoe can include a “High-Tech” insert or sole with replaceable “skins” (i.e., similar to phone covers used with current smart phones) to allow a user to customize their shoe look and/or type (i.e., sneakers and hiking shoes could be designed using the same adaptable sole but with different “skins”). Various embodiments can include multiple colors and/or external shapes/sizes/designs for shoe, and the “inserts” or “skins” could optionally alter shoe performance (i.e., the “skin” is “recognized” by the sole upon attachment and reconfigures the sole performance as described herein) or sole/shoe performance could be user controlled. In various alternative embodiments, the sole could comprise an insert or “cartridge” that is inserted into the shoe body and/or through an opening in the heel.

In one alternative embodiment shown in FIGS. 25A and 25B, a shoe could accommodate multiple types of replaceable sole cartridges, allowing a single shoe skin to incorporate different performing soles.

Universal Shoe

In various embodiments, IAS arrays and buckling structures can be incorporated into a single shoe design to accommodate a variety of feet sizes (i.e., sizes 10 through 12 in a single shoe). In these arrangements, buckling structures can be disposed in various locations and shoe components to accommodate multiple wearers and/or feet that grow very quickly (i.e., toddler shoes). Such designs can be particularly useful for small children as they grow, as well as multiple family members and/or members of sports teams having limited equipment availability for sharing between players, etc.

In various embodiments, the adaptable shoe designs described herein could be combined with different shoe “skins” to alter look (i.e., color) as well as performance (i.e., hiking shoe and running shoe combo—with each “skin” altering shoe performance properties when attached thereto.)

If desired, shoe designs could incorporate programmable and/or reprogrammable features to accommodate athlete training (i.e., increased training resistance at certain points in an activity cycle) and/or performance enhancement (i.e., for assisting the user take a jump shot with less sole rebound, but allowing for landing from the jump shot with more softness, and then facilitate running down court with more lateral stiffness in the shoe for cutting moves). If desired, a shoe design could include sensor features that might allow a computer to “predict” potential desired shoe characteristics, and the system could alter IAS array performance based on outside factors (i.e., changing the shoe performance when a basketball or net is within a desired proximity of the sole or player, or stiffening a shoe sole when a baseball or plate/base is nearby during pitching and/or batting activities during baseball).

In a similar manner, shoe designs can be particularized for a sport that requires different impact response, such as triathlete competitions, in which running, swimming and biking could all potentially be optimized using a single adaptable shoe design. In one exemplary example, an IAS array could incorporate external fittings and/or sensors to identify when the shoe is attached to a bike pedal (i.e., bike peg mounts), or when the shoe is immersed in water during swimming (at which point the shoe may assume maximum flexibility of the sole to assist with kicking the user's foot in the water), and the system could alter the shoe performance accordingly (i.e., the shoe could incorporate external mounting points to alter performance with toe pegs that stiffen the sole or toe box for biking when engaged, while removal of the pegs from bike softens the sole/toe box for running).

### INCORPORATION BY REFERENCE

The entire disclosure of each of the publications, patent documents, and other references referred to herein is incorporated herein by reference in its entirety for all purposes to the same extent as if each individual source were individually denoted as being incorporated by reference.

### EQUIVALENTS

The invention may be embodied in other specific forms without departing from the spirit or essential characteristics thereof. The foregoing embodiments are therefore to be considered in all respects illustrative rather than limiting on the invention described herein. The scope of the invention is thus intended to include all changes that come within the meaning and range of equivalency of the descriptions provided herein.

Many of the aspects and advantages of the present invention may be more clearly understood and appreciated by reference to the accompanying drawings. The accompanying drawings are incorporated herein and form a part of the specification, illustrating embodiments of the present invention and together with the description, disclose the principles of the invention.

Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the disclosure herein.

What is claimed:

1. A shoe sole comprising at least an outsole and a cushioning midsole, the midsole comprising:
an upper layer
a lower layer spaced apart from the upper layer to define a space, the lower layer being proximate to the outsole; and
an interface layer disposed in the space between the upper layer and the lower layer, the interface layer comprising a plurality of filaments, each of the plurality of filaments comprising a first end proximal to the upper layer and a second end proximal to the lower layer, each of the plurality of filaments having a longitudinally extending filament axis;
wherein at least a portion of the plurality of filaments are configured to buckle in response to an external incident force on the shoe sole.

2. The shoe sole of claim 1, wherein the buckling comprises a localized lateral deflection of a central region of each of the plurality of filaments.

3. The shoe sole of claim 1, further comprising a polyurethane foam disposed in the space, the polyurethane foam surrounding at least a portion of the plurality of filaments.

4. The shoe sole of claim 1, wherein the plurality of filaments is enclosed within an airtight enclosure within the space.

5. The shoe sole of claim 1, wherein the plurality of filaments comprise a material selected from the group consisting of a foam, an elastomer, a polymer, a metal, a natural rubber and an artificial rubber.

6. The shoe sole of claim 1, wherein at least a portion of the plurality of filaments have a non-circular cross-section.

7. The shoe sole of claim 1, wherein the plurality of filaments comprise a first plurality of filaments and a second plurality of filaments, the first plurality of filaments having a first buckling response and the second plurality of filaments having a second buckling response, the first and second buckling responses being different buckling responses.

8. The shoe sole of claim 7, wherein the first plurality of filaments is located in a proximal region of the shoe sole and the second plurality of filaments is located in a distal region of the shoe sole.

9. The shoe sole of claim 1, wherein the plurality of filaments have a first average filament spacing in a first region of the shoe sole and a second average filament spacing in a second region of the shoe sole, the first and second average filament spacings being different spacings.

10. The shoe sole of claim 1, wherein at least a first portion of the plurality of filaments are attached to the upper and lower layers, and a least a second portion of the plurality of filaments are attached to only one of the upper or lower layers.

11. The shoe soles of claim 1, wherein least a portion of the plurality of filaments are hollow.

12. A shoe with an adaptable sole, comprising:
an upper layer
a lower layer spaced apart from the upper layer to define a space, the lower layer being proximate to the outsole; and
an interface layer disposed in the space between the upper layer and the lower layer, the interface layer comprising a plurality of filaments, each of the plurality of filaments comprising a first end proximal to the upper layer and a second end proximal to the lower layer, each of the plurality of filaments having a longitudinally extending filament axis;
a peripheral wall substantially enclosing the space containing the plurality of filaments, the peripheral wall being substantially more rigid in a lateral direction than the plurality of filaments;
wherein at least a portion of the plurality of filaments can be selectively configured to buckle in a first or second manner in response to an external incident force on the shoe sole.

13. The shoe with an adaptable sole of claim 12, wherein the selective configuration of the buckling in the first or second manner is primarily dependent upon the intensity of the external incident force.

14. The shoe with an adaptable sole of claim 12, wherein the selective configuration of the buckling in the first or second manner is primarily dependent upon the direction of the external incident force.

15. The shoe with an adaptable sole of claim 12, wherein the selective configuration of the buckling in the first or second manner is manually selected by the user.

16. The shoe with an adaptable sole of claim 12, further comprising at least one sensor capable of sensing the external incident force on the shoe sole and transmitting a sensed data to a remotely located computing device, and the selective configuration of the buckling in the first or second manner is controlled by the remotely located computing device.

17. A cushioning insert for a shoe sole having an upwardly facing recess to accommodate the cushioning insert, comprising
an upper layer
a lower layer spaced apart from the upper layer to define a space, the lower layer being proximate to the outsole; and
an interface layer disposed in the space between the upper layer and the lower layer, the interface layer comprising a plurality of vertically oriented filaments, each of the plurality of vertically oriented filaments comprising a first end proximal to the upper layer and a second end proximal to the lower layer, each of the plurality of vertically oriented filaments having a longitudinally extending filament axis;
wherein at least a portion of the plurality of the vertically oriented filaments are regularly spaced apart and are configured to buckle in response to an external incident force on the shoe sole.

18. The cushioning insert for a shoe sole of claim 17, wherein the insert further comprises an airtight bladder surrounding the plurality of vertically oriented filaments, the airtight bladder including an external valve.

19. The cushioning insert for a shoe sole of claim 17, wherein the cushioning insert comprises a c-shaped insert configured for insertion into the upwardly facing recess located at a heel area of the shoe sole.

20. The cushioning insert for a shoe sole of claim 17, wherein the cushioning insert comprises an oval-shaped insert configured for insertion into the upwardly facing recess located at a foot-ball area of the shoe sole.
